(19) United States
(12) Patent Application Publication
(10) Pub. No.: US 2002/0055963 A1
(43) Pub. Date: May 9, 2002

(54) Data interchange system, data interchange instrument and method thereof

(76) Inventors: Yasuhiko Kanemasa, Kawasaki (JP); Nobuyuki Kanaya, Kawasaki (JP); Hirotaka Hara, Kawasaki (JP)

Correspondence Address: STAAS & HALSEY LLP, 700 11TH STREET, NW, SUITE 500, WASHINGTON, DC, 20001, US

(21) Appl. No.: 09/816,372

(22) Filed: Mar. 26, 2001

(30) Foreign Application Priority Data
Nov. 6, 2000 (JP) 2000-337028

(51) Int. Cl. G06F 9/00

(52) U.S. Cl. 709/102

(57) ABSTRACT

In a data interchange system that executes a series of process flows among plurality of process executing devices, each process executing device is provided with a unit for interchanging process executing data with other device, and a unit for interchanging with other device interprocess association information that associates a process executed by one device with a process executed by other device, and it performs interchanging of process executing data and of interprocess association information, for example, at a different timing that is not synchronized between both of them. Even a system that has no mechanism for associating processes with one another is thereby enabled to realize associating processes with one another.

### BACKGROUND OF THE INVENTION

1. Field of the Invention

This invention relates to a data interchange system that interchanges data among a plurality of systems and executes a process, and, to be more specific, it relates to an intersystem linkage work-flow system that executes a series of processes (tasks and works) in cooperation with plurality of systems. Along with the rapid change that has occurred to the business environment in the recent years, a change of process linkage among many systems that were not taken into consideration at the time of designing the system is required. This invention relates to an intersystem linkage work-flow system that can realizes a process linkage among the plurality of systems, even if it is a system that has no mechanism for such a linkage process, for example, to an intercorporation EDI (electronic data interchange) system.

2. Description of the Related Art

In an intersystem linkage work-flow system, a series of processes, for example, a series of tasks and works are executed in linkage with one another among a plurality of systems. In this case, each system is thought to exist in a plurality of corporations or to exist in a plurality of departments in a corporation. As a result of the recent trend of active M&As (mergers and acquisitions), there is no essential difference between “in a corporation (intra-corporation)” and “among corporations (inter-corporation)”.

In a conventional intersystem linkage work-flow system, for example, in a conventional intercorporation EDI system, a common process identifier is used to associate one system with another system when a series of processes are executed among a plurality of systems or among a plurality of corporations.

In such a conventional system, a system that executes a first process among a series of process flows, or a corporation that executes a first process among a series of process flows appends an identifier unique to the process, and, when sending data for executing the process, for example, a slip, the system transfer the slip together with the process identifier to transfer the process flow to another system or another corporation.

In the system that has received data for executing the process, for example, the slip and process identifier, since the same process identifier is used for a series of process flows on each system by appending the same identifier to the process that is executed in accordance with, for example, the slip, it is possible to uniquely identify said series of process flows among a plurality of systems or among a plurality of corporations. When one wants to inquire about a process, for instance, on another system, one can inquire about it using the process identifier appended to that process.

In such a conventional system in which a common process identifier is used, there are the following two problems. The first problem is that even if there is a unit for transferring data for executing a process, for instance, a slip among a plurality of systems, the linkage among a plurality of systems cannot be well coordinated when a mechanism for transferring a process identifier has not been prepared.

In most work-flow systems that are originally designed on the premise that they are linked among a plurality of systems, a mechanism for transferring a process identifier is prepared. However, in a work-flow system that is originally designed without considering the linkage among a plurality of systems, no mechanism for transferring process identifier is prepared even if one wants to subsequently perform data interchange among a plurality of systems.

In particular, when the same slip standard is used among a plurality of corporations, it is possible to combine some items in the slip and use the combined items as a process identifier, but when the slip standard is different among the corporations, the process identifier cannot be transferred from one corporation to another.

The second problem is how to append a process identifier for the first process in a series of process flows. The first system or the first corporation that executes a series of process flows is not necessarily only one system or one corporation. For instance, when a corporation receives orders from a plurality of corporations and processes the orders in one transportation request process, the processes executed by a plurality of systems or a plurality of corporations are all taken over by another system or another corporation. How to append a process identifier cannot be determined in such a case.

Next, associating processes with each other sometimes becomes a problem not only among a plurality of systems or a plurality of corporations but also in a system or a corporation. When a process of another system or another corporation enters an application flow in one system or one corporation, a problem occurs in which that the process, before being transferred to another system or another corporation, cannot be associated with the process after being sent back from another system or another corporation. For instance, even if an ordering process has been transformed into electronic data, a quote is made on paper, and such a case as this gives rise to such a problem. In such a case, it is necessary to manually associate processes with each other.

Moreover, when an intersystem process association is executed among a number of systems, the cost for communications required for interchanging information about association processes with each other becomes high. In addition to this problem, there is such a problem that the management of the addressees to whom the information about association processes with each other has been distributed becomes difficult.

### SUMMARY OF THE INVENTION

The purpose of this invention is to provide a intersystem linkage work-flow system that associates systems with one another by interchanging the process executing data with the interprocess association information independently among the systems, and to provide an intersystem linkage work-flow system that associates processes with each other in one system using the intersystem association information that has been sent from another system, helping to reduce the cost required for communications to interchange interprocess association information among plurality of systems, and helping to easily manage the addressees to whom the interprocess association information has been distributed.

According to an embodiment of this invention, in a data interchange system for executing a series of process flows among a plurality of process executing devices, the process executing device comprises a process executing data interchanging unit and an interprocess association information interchanging unit. The process executing data interchanging unit interchanges process executing data for executing a process with other process executing device. The interprocess association information interchanging unit interchanges with the other process executing device of interprocess association information that associates the process executed by the process executing device with the process executed by the other executing device.

Here, interprocess association information can be information that associates processes with each other using part of the process executing data, and can be information that associates processes with each other using part of the process executing data and the data in which an exclusive value is taken each time a series of process flows are executed.

In the above-mentioned configuration, the interprocess association information interchanging unit can interchange interprocess association information using a transfer method different from the unit for interchanging the process executing data, or it can interchange interprocess association information at the timing which is not synchronized with the timing of the interchange of data by the unit for interchanging the executing data, or it can collectively interchange interprocess associating non-synchronously and periodically.

Also, the interprocess association information interchanging unit can dynamically determine the device of the other party to whom interprocess association information is sent using part of the process executing data when said information is sent.

In the above-mentioned configuration, the process executing device can further comprise an association definition storing unit storing a method to define the interprocess association of processes with each other as an association definition and an association unit associating the process executed by the process executing device with the process executed by the other process executing device. The process executing device can also comprise a device interprocess association unit associating the processes executed by the process executing device that are identical to the process executed by the other process executing device using the interprocess association information transmitted from the other process executing device.

Also, The data interchange system can comprise, for example, an association information distribution server. The server comprises an interprocess association information storing unit storing interprocess association information that associates a process executed by one process executing device with a process executed by another process executing device and that is transmitted from the plurality of process executing devices, and an interprocess association information distribution unit distributing the stored interprocess association information to a related process executing device.

In the above-mentioned configuration, for instance, the association information distribution server may also comprise an addressee definition storing unit storing how to determine an address to whom interprocess association information is distributed as an addressee definition. The interprocess association information distribution unit can dynamically determine the addressee of association information using part of the process executing data when transmitting said information.

Also, the data interchange system may comprise an interprocess association server within the system. This server comprises an interprocess associating unit associating the processes with each other that are executed by the process executing device using data that are transmitted from plurality of process executing devices, and an interprocess association information distribution unit distributing interprocess association information that is made by the interprocess association unit to a related process executing device.

The data interchange device of this invention is an device that interchanges data concerning a process with an external device to execute a work process that is included in a series of process flows, and comprises an executing data interchanging unit interchanging process executing data with an external device, and an interprocess association information interchanging unit interchanging with an external device the interprocess association information that associates a process executed by one device with a process executed by other process executing device.

In another embodiment of this invention, to execute a process included in a series of process flows, such a method is used that the process executing device interchanges data concerning the process with an external device and interchanges with an external device interprocess association information that associates a process executed by the device with a process executed by an external device at the same timing as the timing at which the data for executing said process is interchanged or at a timing different from the timing of interchanging the data for executing the process.

In the above-mentioned method, a data transfer method different from that for interchanging process executing data with an external device can be used in interchanging this interprocess association information with an external device.

According to another embodiment of this invention, to execute a process included in a series of process flows, a computer readable storage medium that stores a program that makes a computer execute such steps that process executing data is interchanged with an external device as a storage medium that is used by a computer that interchanges data concerning said process with an external device, and that interprocess association information that associates a process executed by the computer with a process executed by the external device is interchanged with the external device at the same timing as the timing at which the data for executing said process is interchanged or at a timing different from the timing at which the data for executing said process is interchanged.

In the above-mentioned embodiment, a data transfer method different from that for interchanging process executing data with an external device can be used by a computer in the step for interchanging this interprocess association information with an external device.

Therefore, this invention makes it possible to perform both interchanging process executing data and interchanging interprocess association information executed among plurality of process executing devices, for example, at a different timing among plurality of process executing devices that compose a data interchange system to execute a series of process flows.

### BRIEF DESCRIPTION OF THE DRAWINGS

The features and advantages of the present invention will be more clearly appreciated from the following description when taken in conjunction with the accompanying drawings in which like elements are denoted by identical reference numerals, and in which:

FIG. 1 is a block diagram showing a principle configuration of this invention;

FIG. 2 is a schematic diagram showing a process flow to explain an embodiment of this invention;

FIG. 3 is a schematic diagram showing how to manage a process identifier in the mode for realizing this invention;

FIG. 4 is a schematic diagram showing an example of using information about the corresponding relationship between a process and a slip as a kind of interprocess association information;

FIG. 5 is a schematic diagram showing an example of using information about the corresponding relationship between a process and an item value as interprocess association information (No. 1);

FIG. 6 is a schematic diagram showing an example of using information about the corresponding relationship between a process and an item value as interprocess association information (No. 2);

FIG. 7 is a schematic diagram showing the association of processes with each other that one corporation executes using interprocess association information transmitted from another corporation;

FIG. 8 is a block diagram showing the configuration of an EDI system in a corporation;

FIG. 9 is a diagram showing items of each slip used in the mode for realizing this invention;

FIG. 10 is a diagram showing stored contents of association index;

FIG. 11 is a flowchart showing the processing of associating processes with each other using a slip identifier;

FIG. 12 is a diagram showing examples of the contents of the association index made by the processing shown in FIG. 11;

FIG. 13 is a flowchart showing the process of association processes with each other using a key item of the slip;

FIG. 14 is a diagram showing examples of the contents of the association index made by the processing shown in FIG. 13;

FIG. 15 is a flowchart showing the process of association processes with each other in one corporation using interprocess association information received from another corporation;

FIG. 16 is a diagram showing examples of the contents of the association index made by the processing shown in FIG. 15;

FIG. 17 is a diagram showing an example of transmitting and receiving process executing data and interprocess association information by a different transfer method;

FIG. 18 is a diagram showing the timing of transmitting interprocess association information;

FIG. 19 is a diagram showing an example of transmitting and receiving interprocess association information collectively;

FIG. 20 is a diagram showing an example of interchanging interprocess association information when one inquires about a process (No. 1);

FIG. 21 is a diagram showing an example of interchanging interprocess association information when one inquires about a process (No. 2);

FIG. 22 is a diagram showing an example of dynamically determining an addressee of interprocess association information;

FIG. 23 is a diagram showing an embodiment for association processes with each other based upon the association definition of association;

FIG. 24 is a diagram showing an association information distributing server provided in an intersystem linkage work-flow system;

FIG. 25 is a diagram showing an embodiment of an association information distributing server to dynamically determine an addressee;

FIG. 26 is a diagram showing an embodiment of an association information distributing server to determine an addressee based upon the definition of addressee;

FIG. 27 is a diagram showing an interprocess association server provided in an intersystem linkage work-flow system;

FIG. 28 is a diagram showing loading a program into a computer for realizing this invention.

### DESCRIPTION OF THE PREFERRED EMBODIMENTS

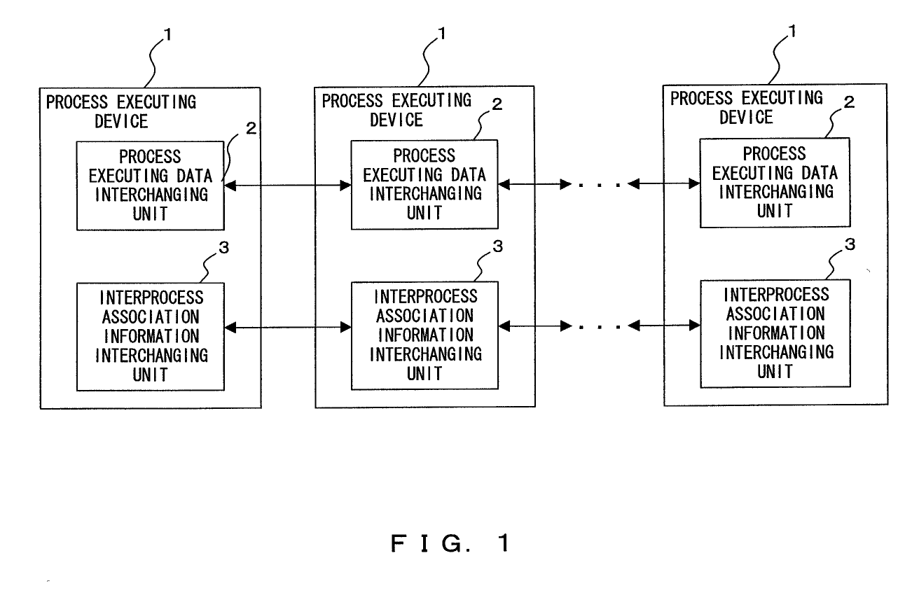

FIG. 1 is a block diagram showing the principle configuration of this invention, and is a block diagram showing the configuration of a data interchange system that executes a series of process flows among a plurality of process executing devices 1 that execute a process as a work (job).

The process executing device 1 shown in FIG. 1 is, for example, an in-house EDI (electronic data interchange) system, and a data interchange system, for example, an intercorporation EDI system, is composed of a plurality of process executing devices 1.

A process executing device 1 is provided with a process executing data interchanging unit 2 and an interprocess association information interchanging unit 3. The executing data interchanging unit 2 is, for example, a slip transmitting and receiving system that interchanges process executing data, for instance, a slip with another process executing device 1.

The interprocess association information interchanging unit 3 interchanges with another process executing device interprocess association information that associates a process executed by the process executing device with a process executed by the other process executing device, and is, for instance, an association information interchanging module.

Even a work-flow system, if being configured as has been described, which has no mechanism for transmitting and receiving a process identifier can associate processes with one another among a plurality of systems (process executing devices) only by transferring process executing data. Since a common process identifier is not used among a plurality of systems, one process can be associated with the other process even when the top of the process has not been determined.

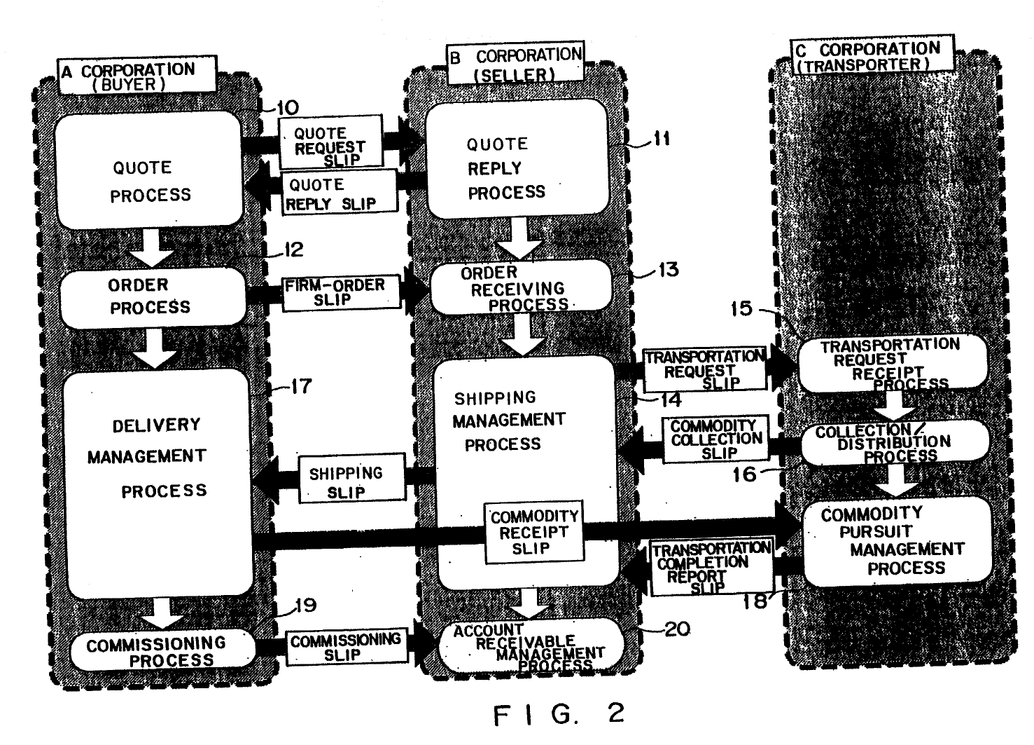

FIG. 2 is a flowchart showing an example of a process flow in which the intersystem linkage work-flow system of this invention executes a series of processes among a plurality of corporations while interchanging a slip as the process executing data among them. Described hereinafter is the mode for realizing the invention using this process flow as the example.

FIG. 2 shows A corporation as a corporation that places an order(namely, the buyer), B corporation as a corporation that receives the order (namely, the seller) and C corporation as a transporter, and a series of process flows from price estimating to purchasing and transporting executed by these corporations. The vertical direction shows a process flow in each corporation, and the horizontal direction shows interchanging a slip among these corporations.

First, A corporation executes a quote process 10, and sends a quote request slip to B corporation. B corporation executes a quote reply process 11, and sends a quote reply slip to A corporation. Upon receiving the quote reply slip, A corporation executes an order process 12, and send a firm-order slip to B corporation.

B corporation that has receive a firm-order slip executes an order receiving process 13 and a shipping management process 14, and sends a transportation request slip to C corporation to send an ordered commodity to A corporation.

In response to the transportation request from B corporation, C corporation executes a transportation request receipt process 15 and a commodity collection and distribution process 16, goes to B corporation to collect the commodity, and sends a commodity collection slip to B corporation. Then, B corporation sends a shipping slip to A corporation as a work (job) in the delivery management process 14 to inform A corporation that B corporation has forwarded the commodity to A corporation.

Upon receiving the shipping slip, A corporation executes a commodity delivery management process 17, and sends a commodity receipt slip to C corporation upon receiving the commodity from C corporation to inform C corporation that A corporation has received the commodity. C corporation executes a commodity pursuit management process 18 upon receiving the commodity receipt slip, and sends a transportation completion report slip to B corporation to inform B corporation that C corporation has completed the transportation of the commodity. On the other hand, A corporation executes a commissioning process 19 in succession to a commodity delivery management process 17, and comfirms the received commodity and sends a commissioning slip to B corporation, and then B corporation executes an account receivable management process 20 upon receiving the commissioning slip.

An intercorporation EDI system as an example of such an intersystem linkage work-flow system sometimes requires a work (job) for tracing the association of the slip, which is called slip tracking. For instance, when a person receives a question from someone else indicating that there was an error in the contents of a quote reply slip, the person has to perform a check, based upon which quote request slip was made, by way of slip tracking to check the cause of the error. Also, in order for the seller to explain to the buyer how the ordered commodity is being processed, the seller needs to know in what process the seller requested the transporter to collect and transport the ordered commodity, by way of slip tracking. To perform such slip tracking among a plurality of corporations, it is necessary to associate processes with one another among a plurality of corporations.

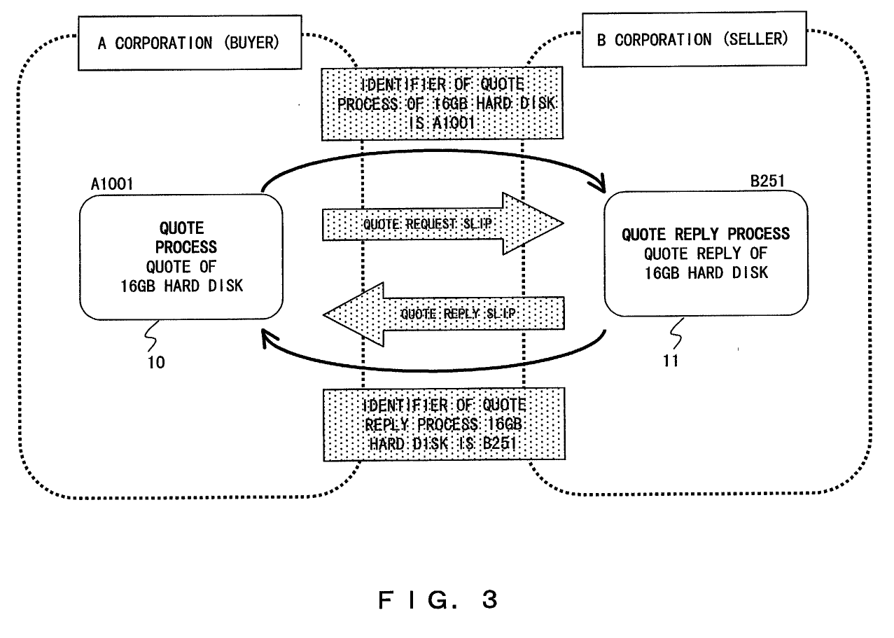

Described below is a basic interprocess association method in the mode for realizing the invention corresponding to the process flow shown in FIG. 2, with reference to FIG. 3 to FIG. 7. FIG. 3 is a schematic diagram showing how to manage a process identifier in the mode for realizing this invention. A corporation appends a process identifier “A1001” to a certain quote process 10, and B corporation appends a process identifier “B251” to a quote reply process 11.

The two processes, A1001 and B251, can be associated by interchanging information about how to append a process identifier to the quote process of a 16 GB hard disk, for example, apart from a slip, between A corporation and B corporation. When A corporation makes an inquiry to B corporation in relation with the process of identifier A1001 later, A corporation becomes able to make an inquiry using the identifier of B251.

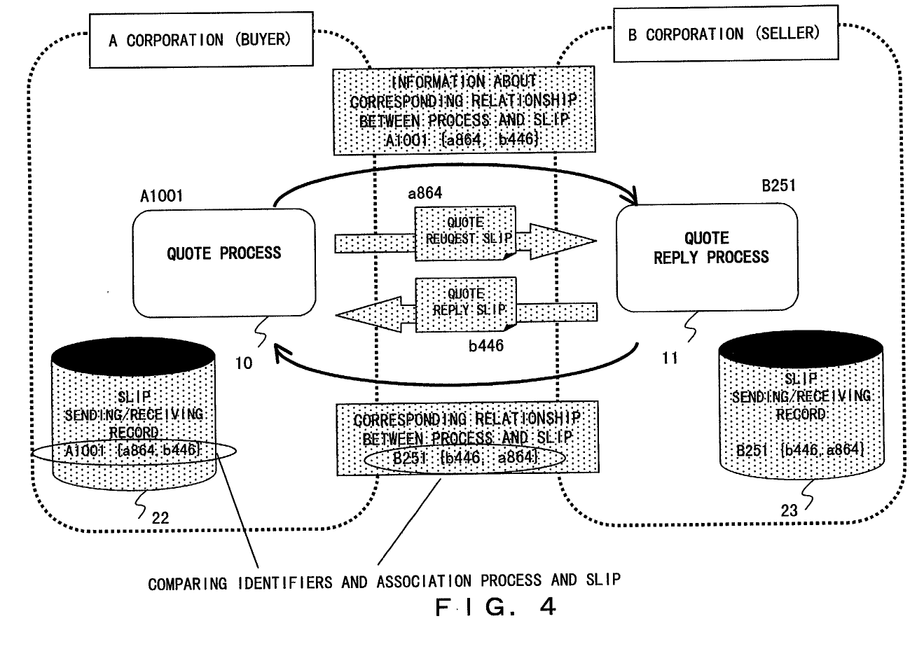

FIG. 4 is a schematic diagram showing an example of using information about the corresponding relationship between a process and a slip as a kind of interprocess association information. When one process is associated with another among a plurality of corporations, the association is performed by using a corresponding relationship between a process and a slip. A corporation sends a slip with identifier a864 to B corporation in the quote process 10 with identifier A1001, and sends information about a corresponding relationship between the process and the slip to B corporation to inform B corporation that A corporation has received a quote reply slip with identifier b446 from B corporation.

On the other hand, B corporation sends a quote reply slip with identifier b446 to A corporation in the quote process with identifier B251, and sends information about a corresponding relationship between the process and the slip to A corporation to inform A corporation that B corporation has received a quote request slip with identifier a864, thus making it possible to mutually associate processes of both corporations.

In FIG. 4, after a quote request slip and a quote reply slip are sent between both corporations, information about a corresponding relationship between a process and a slip is mutually sent and received; the corresponding relationship between a process and a slip is stored as a slip sending and receiving record 22 on the side of A corporation and as a slip sending and receiving record 23 on the side of B corporation; the quote process with identifier A1001 can be associated with the quote reply process with identifier B251 by comparing the slip sending and receiving record and the information about a corresponding relationship between a process and a slip.

It is presumed that in FIG. 4 each corporation appends a unique identifier to a slip as process executing data, as mentioned above. However, even if an identifier is not appended, it is possible to associate processes with each other by using an item in the slip independently or combined items in the slip in place of an identifier, or by identifying the slip by all the slip contents, thus greatly reducing the processing burden as compared with the case where the whole slip is compared as the process executing data.

For instance, even when an item for a slip identifier exists in the slip and when it is an identifier unique only to the corporation that sends the slip, a combination of the identifier with the name of the corporation that sends the slip can be used in place of a unique slip identifier among a plurality of corporations. Also, in a system that does not send a plurality of slips simultaneously, a combination of the date and time the slip is sent and the name of the corporation that sends the slip can be used in place of a unique slip identifier.

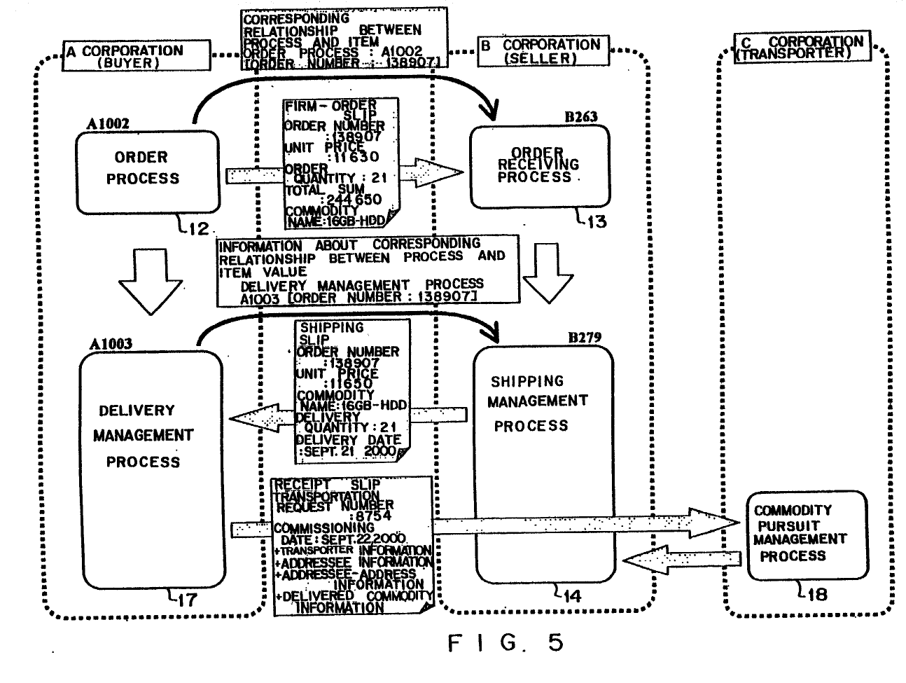

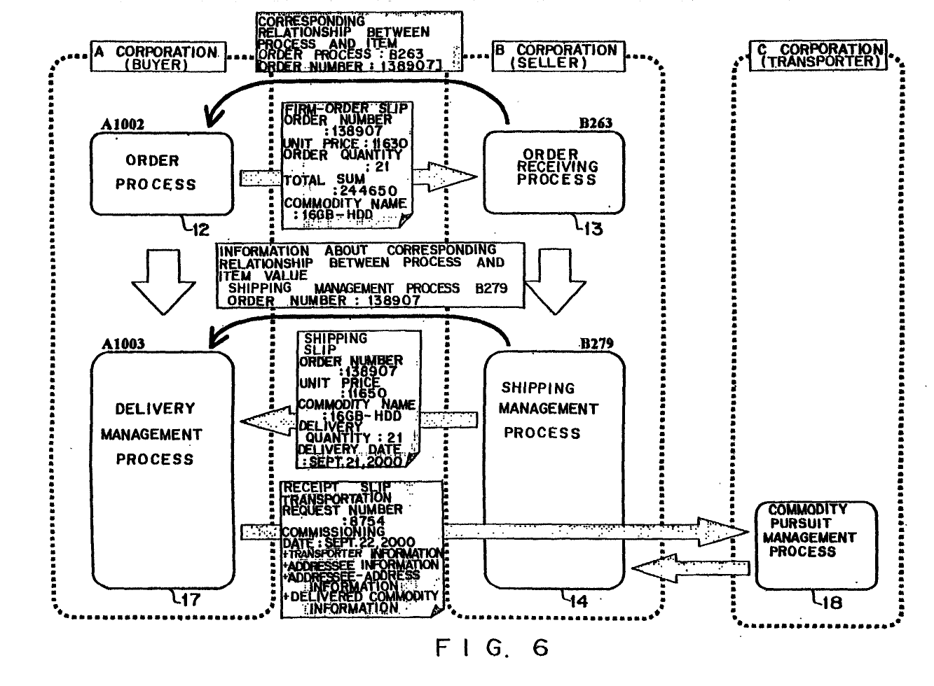

FIG. 5 and FIG. 6 are schematic diagrams showing an example of using information about the corresponding relationship between a process and an item value as interprocess association information. In these diagrams, a slip item that takes an exclusive value in each process of a series of process flows is used to associate processes with each other among a plurality of corporations. In this example, the order number appears in the firm-order slip and in the shipping slip, and the same value for it is carried over. Therefore, this item value cannot be used to identify the slip itself, but can be used to uniquely identify a series of process flows from the order process 12 to the delivery management process 17 in the process flow in which the commodity is handled.

In FIG. 5, A corporation sends B corporation information stating that the order number 138907 was used in the order process 12 with identifier A1002, and A corporation also sends B corporation information stating that the order number 138907 was used in the delivery management process 17 with identifier A1003. B corporation can become aware that A1002 is the identifier for the process of A corporation that is related to the order receiving process 13 with identifier B263 on the side of B corporation, and that A1003 is the identifier for the process of A corporation that is related to the shipping management process 14 with identifier B279 on the side of B corporation.

In FIG. 6, likewise, B corporation sends A corporation information stating that the order number 138907 was used in the order receiving process 13 with identifier B263 and in the shipping management process 14 with identifier B279, and A corporation can know that B263 is the identifier for the process of B corporation that is related to the order process 12 with identifier A1002 on the side of A corporation, and that B279 is the identifier for the process of B corporation that is related to the delivery management process 17 with identifier A1003 on the side of A corporation.

Please note that in FIG. 5 and FIG. 6, there is no item for order number in the slip that is sent to C corporation from the delivery management process 17 with identifier A1003 of A corporation, but there is, instead, a transportation request number, an item that takes an exclusive value at each process in a series of process flows. Associating the delivery management process 17 with identifier A1003 with the commodity pursuit management process 18 of C corporation is performed between A corporation and C corporation by using the value of the item of this transportation request number. Also, many items other than the order number and transportation request number are described in each slip in FIG. 5 and FIG. 6, and these items will be explained later in this specification.

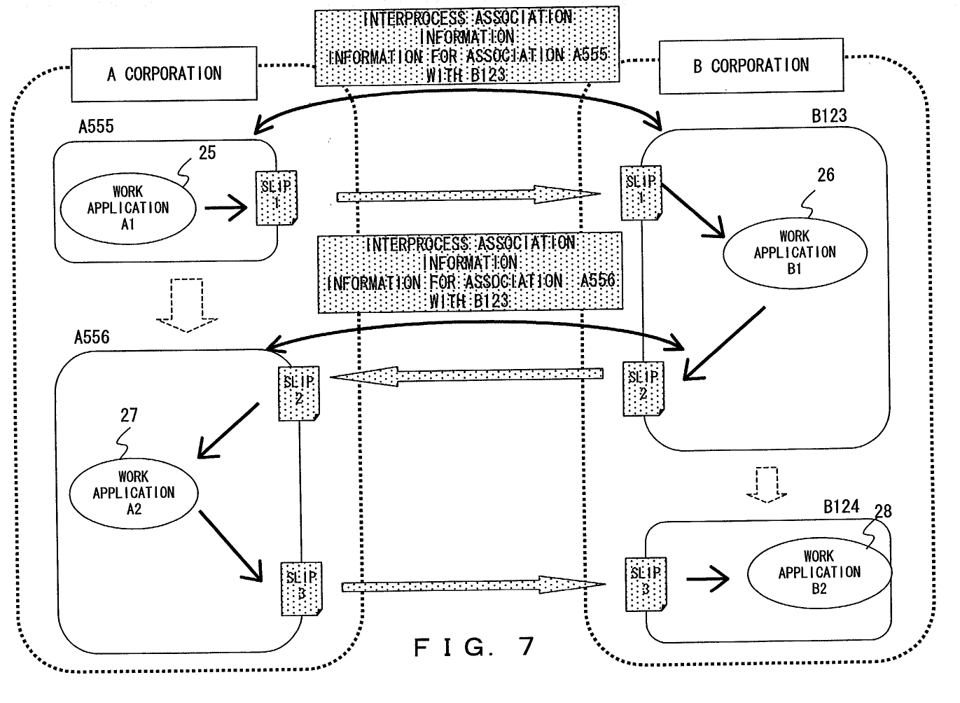

FIG. 7 is a schematic diagram showing the association of one process with the other that one corporation executes using interprocess association information transmitted from another corporation. Suppose that in FIG. 7, the process with identifier A555 of A corporation is not associated with the process with identifier A556 of A corporation. Such a case as this is likely to occur when no consideration was given to the linkage between one process and the other in designing each work application in a corporation. In each work application, a slip is sent and received only once, and as a result, an independent process is executed for each work application, so that association processes with each other is not performed. In this embodiment, it is possible to associate processes that are not associated in a corporation by using information that associates processes with each other between two corporations.

In FIG. 7, in the process with identifier A555 of A corporation, a slip 1 is sent to B corporation by a work application (A1) 25, and on the side of B corporation the processing for the slip 1 is performed by a work application (B1) 26 in the process with identifier B123, and as a result, a slip 2 is sent to A corporation. On the side of A corporation the processing for the slip 2 is performed by a work application (A2) 27 in the process with identifier A556, and as a result, a slip 3 is sent to B corporation. Then, the processing for the slip 3 is performed by a work application (B2) 28 in the process with identifier B124 on the side of B corporation.

In FIG. 7, as in FIG. 5 and FIG. 6, interprocess association information is sent and received to associate the process with identifier A555 with the process with identifier B123 in compliance with the slip 1, and A corporation can know that the process with identifier A555 and the process with identifier A556 of A corporation are associated with the process with identifier B123 of B corporation, by sending and receiving interprocess association information that associates the process with identifier A556 with the process with identifier B123, and as a result, A corporation can know that the process with identifier A555 is associated with the process with identifier A556.

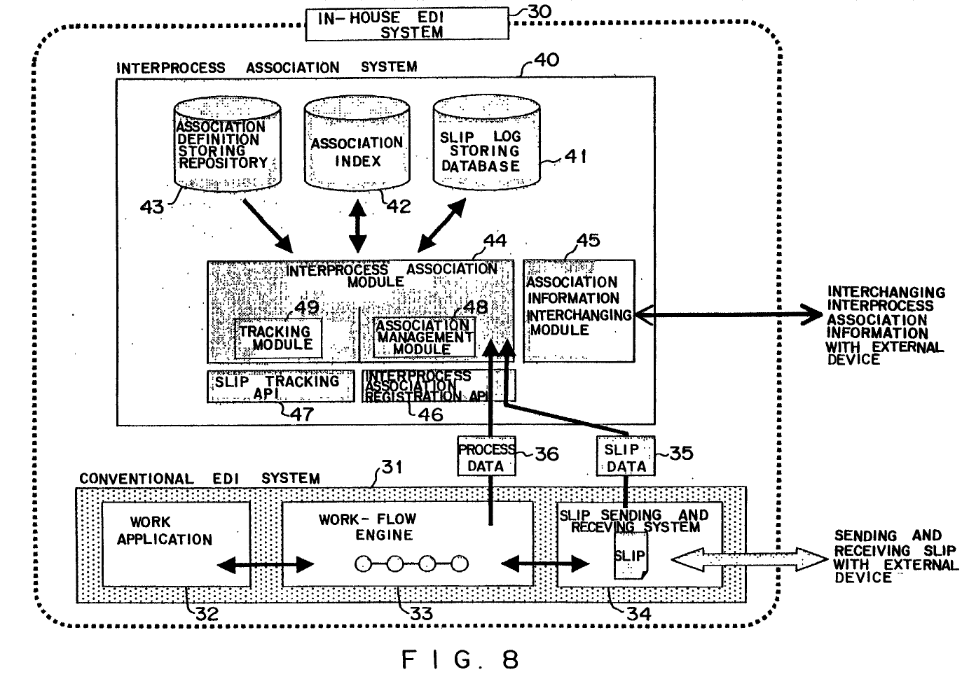

Further described below is the mode for realizing the invention using the system configuration of an intercorporation EDI system as an example of an intersystem linkage work-flow system of this invention. FIG. 8 is a block diagram showing the configuration of an in-house EDI system that is provided in each of a plurality of corporations that have EDI systems among themselves. An intercorporation EDI system is configured by connecting such in-house EDI systems to one another.

An in-house EDI system 30 shown in FIG. 8 is composed of a conventional EDI system 31 and an interprocess association system 40 that is added in the mode for realizing this invention, thus making it possible to associate processes with one another among a plurality of corporations.

The conventional EDI system 31 shown in FIG. 8 comprises a work-flow engine 33 that processes various kinds of work applications 32 in linkage with in-house EDI systems of other corporations, and a slip sending and receiving system 34 that sends and receives a slip to and from in-house EDI systems of other corporations. The conventional EDI system 31 sends a slip 35 and process data 36 to the interprocess association system 40.

The interprocess association system 40 consists of a slip log storing database 41, an association index 42, an association definition storing repository 43, an interprocess association module 44, an association information interchanging module 45, a slip tracking API (application programming interface) 47, and an interprocess association registration API 46.

The slip log storing database 41 is a database that stores slip data that are sent to and received from in-house EDI systems of other corporations. When a person needs to refer to slip information in the above-mentioned slip tracking, the contents of this database is retrieved. It depends upon how the system is used as to whether data of the whole slip are stored or only necessary information are stored.

The association index 42 is an index that retains interprocess association information and rapidly executes a retrieval whenever necessary. The contents of the association index 42 will be described later. The association definition storing repository 43 stores the way how to associate processes with one another. In the case of slip tracking, it is possible to know the method of tracking by using this information.

The interprocess association module 44 consists of an association management module 48 that builds interprocess association information, and a tracking module 49 that performs slip tracking. The association management module 48 stores data required for the association index 42 based upon the slip record sent to and received from other corporations as well as interprocess association information obtained from other corporations, and it sends interprocess association information to other corporations via the association information interchanging module 45.

The tracking module 49 performs tracking using the contents of the association index 42 based upon the tracking method stored in the association definition storing repository 423, when, for example, any other corporation make an inquiry to it, and when information in the slip is required to the reply to the inquiry, the tracking module retrieves the contents of the slip log storing database 41.

The association information interchange module 45 interchanges interprocess association information with EDI systems of other corporations, and the interprocess associating registration API (application programming interface) 46 and the slip tracking API 47 are interfaces for accessing the interprocess association module 44.

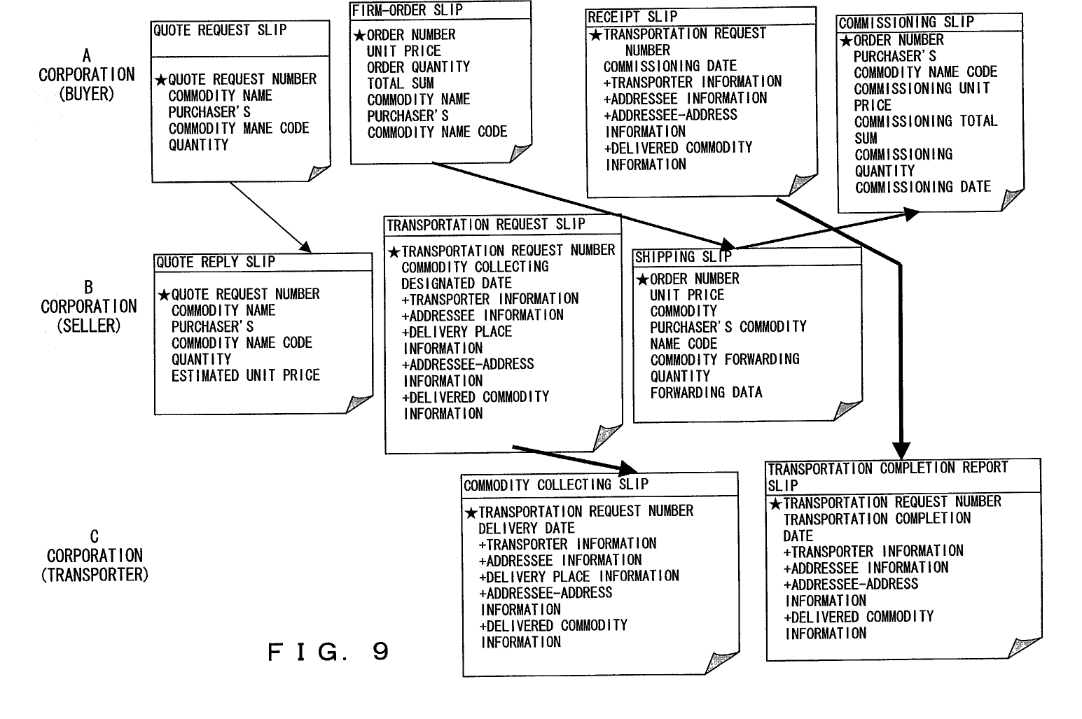

Described in this paragraph are slip items in each slip that is used as an example of a series of process flows shown in FIG. 2. FIG. 9 shows slip items that appear on each slip. For example, described in a firm-order slip are slip items explained in FIG. 5 and FIG. 6, such as order number, unit price, order quantity, order amount, commodity name as well as buyer's commodity-name code for a buyer to identify commodities. The item of an order number marked by ★ shows a slip item that takes an exclusive value in each process of a series of process flows, specifically a key item, which will be explained later.

Each item of the receipt slip shown in FIG. 9 is the same as each item of the receipt slip shown in FIG. 5 and FIG. 6, and the transportation request number is the key item. An item marked by +, for instance, transporter information indicating that there exists more detailed data about that item such as the company name of the transporter, its address, phone number and mail address.

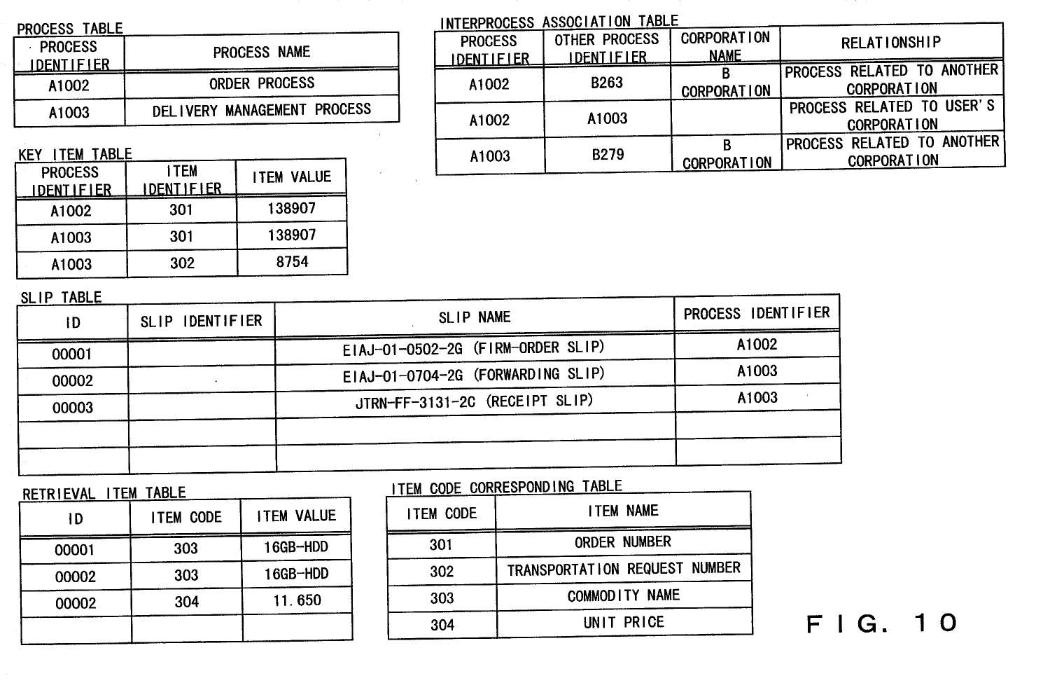

FIG. 10 is a diagram showing the stored contents of the association index 42. The association index 42 is realized as tables on the related databases, and is composed of six tables such as a process table, an interprocess association table, a key item table, a slip table, a retrieval item table and an item code corresponding table.

Shown in FIG. 10 are the contents of the association index that are built by A corporation shown in FIG. 5 and FIG. 6. The process table is used to manage information about each individual process. An order process with identifier A1002 and a delivery management process with identifier A1003 are stored as data in the process table.

Identifier B263 of the process of B corporation and identidier A1003 of the process of A corporation are stored as the other related process identifiers for the process identifier A1002 in the interprocess association table, and identifier B279 of the process of B corporation is stored as the other related process identifier for process identifier A1003 in the interprocess association table.

The key item table stores the name of a key item and its value for each process as a key item that takes an exclusive value in accordance with each process of a series of process flows. The names of key items are encoded for the sake of a high-speed retrieval and of reducing the size of a storage region. FIG. 10 shows that the key item for the process with identifier A1002 and the process with identifier A1003 is 301, and its value is 138907; and that the key item for the process with identifier A1003 is 302, and its value is 8754. This item code 301 shows an order number, and the item code 302 shows a transportation request number.

The slip table is used to manage information of each slip in a process. ID in the slip table is an identifier appended to uniquely identify each slip in the slip log storing database 41 in the system. A slip identifier is an identifier appended to a slip, for instance, a864, as explained in FIG. 4. The name of a slip is stored as a symbol to reduce the size of a storage region, etc., and a process identifier for the process of using each slip is stored in the last column of the slip table.

The retrieval item table stores information about items used for retrieval in a slip in preparation for retrieval of a slip. In this table, 303 is stored as the item corresponding to ID 00001 stored in the slip table, and 303 and 304 are stored as the items corresponding to ID 00002. The item code 303 shows the name of a commodity, and 304 shows the unit price of the commodity.

The item code corresponding table stores a corresponding relationship between an item name and an item code in compliance with an encoded item for the sake of high-speed retrieval and of reducing the size of a storage region, and the names of the items corresponding to the item codes 301 to 304 are stored.

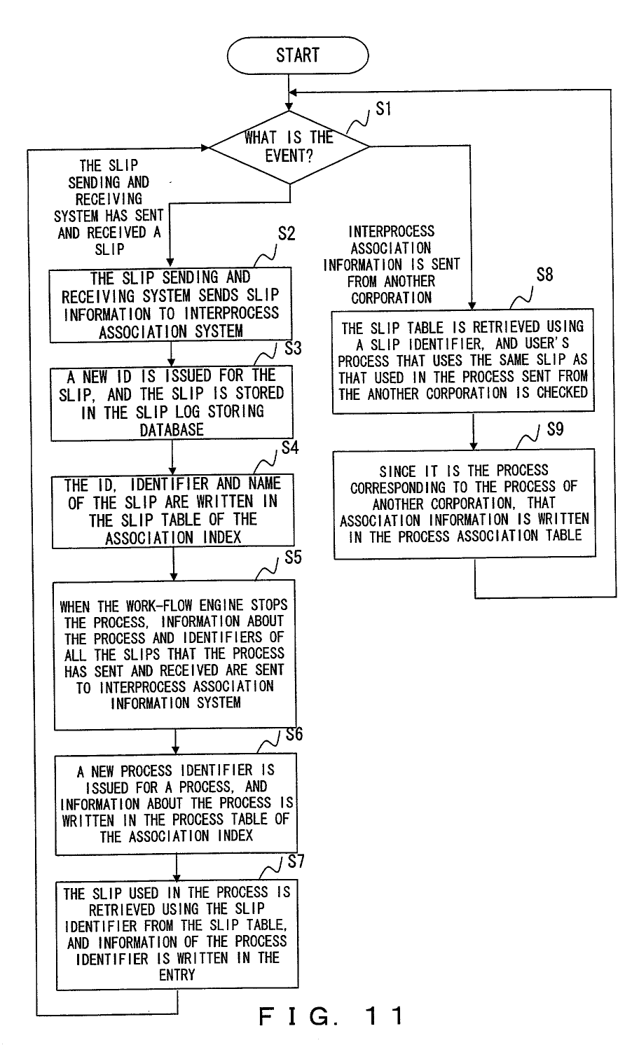

Described next is a flowchart showing the process of association processes with each other using an association index. FIG. 11 is a flowchart showing the process of association processes with each other using a slip identifier.

In FIG. 11, when the processing is started, the occurrence of an event is waited for. When an event occurs, it is judged what the event is in Step S1. If it is judged that a slip has been sent or received by the slip sending and receiving system 34 shown in FIG. 8, slip data 35 is sent to the interprocess association system 40 from the slip sending and receiving system 34 in Step S2, a new ID is issued for the slip in Step S3, the slip data is stored in the slip log storing database 41, and the ID, slip identifier and slip name are written in the slip table in the association index 42 in Step S4.

Before a work-flow engine 33 terminates the process, the process data 36 for the process and the slip identifiers of all the slips that have been sent or received by the process are sent to the interprocess association system 40 in Step S5, a new process identifier is issued for the process in Step S6, information about the process is written in the process table in the association index 42, the slip that was used for the process is retrieved using the slip identifier in Step S7, information about the process identifier is written in the retrieved entry, the process returns to Step S1, and an event is waited for.

If the event that occurred in Step S1 is judged to be interprocess association information sent from other corporations, the slip table is retrieved using the slip identifier in Step S8, and the user can check the process of his or her corporation that uses the same slip as the one used for the process of the other corporation that sent the interprocess association information. The association of the checked process of his corporation with the process of the other corporation is written in the interprocess association table in Step S9, and an event is waited for in Step S1.

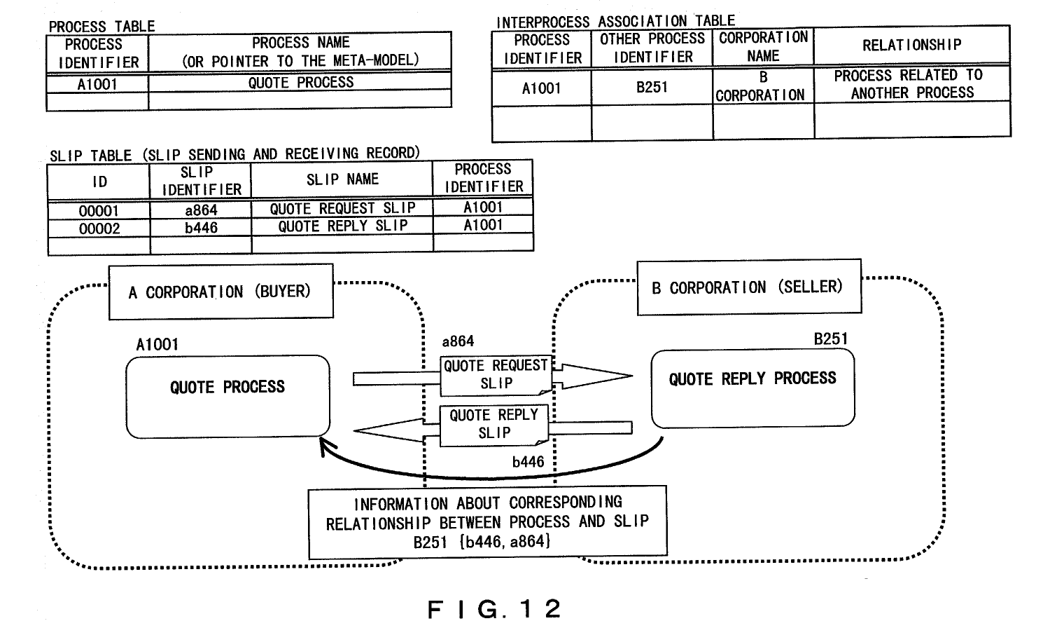

FIG. 12 is a diagram showing the contents such as the process table, interprocess association table and slip table in the association index 42 made on the side of A corporation by the processing shown in FIG. 11. FIG. 12 shows an example of the data stored in the process table, interprocess association table and slip table.

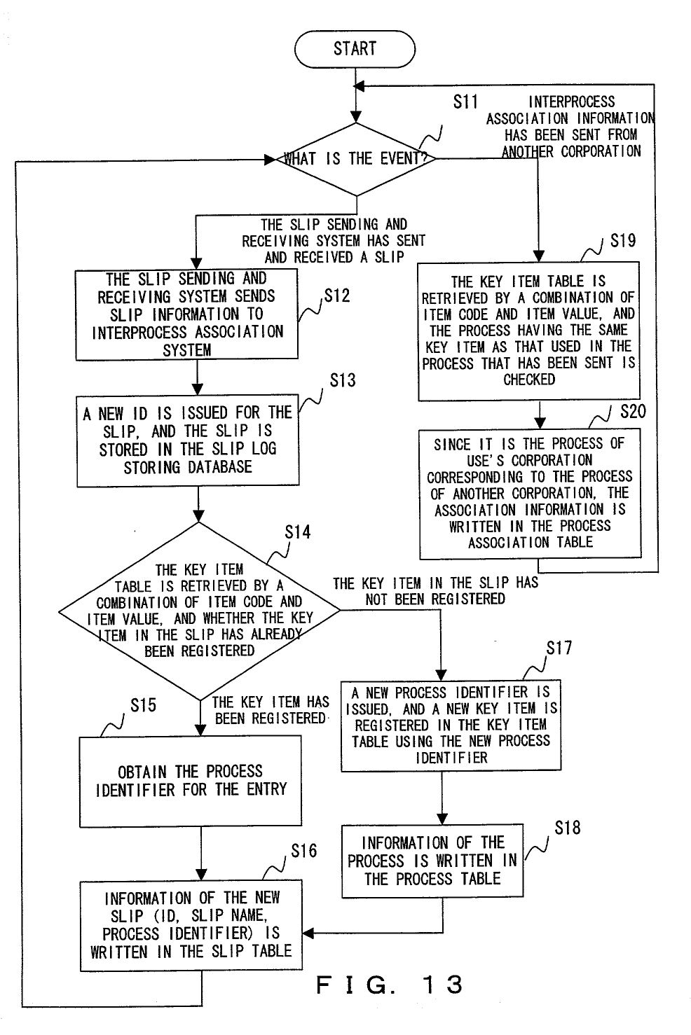

FIG. 13 is a flowchart showing the process of associating processes with each other that uses an exclusive value, specifically a key item of the slip in compliance with a series of process flows, as explained in FIG. 5 and FIG. 6. When the processing is started, first, it is judged what event has occurred in Step S11 in the same way as in FIG. 11. If it is judged that the slip sending and receiving system has sent or received a slip, the slip sending and receiving system sends information about the slip to the interprocess association system in Step S12, a new ID is issued to the forwarded slip in Step S13, the data of the slip is stored in the slip log storing database, the key item table is retrieved by a combination of the item code and the item value in Step S14, and it is checked whether the key item of the forwarded slip has already been registered in the key item table.

If the key item of the forwarded slip has already been registered in the key item table, the process identifier for the entry is pursued in Step S15, and the ID, slip name and process identifier are written in Step S16 as information about the new slip that has been sent to the slip table, and then, the process returns to the process of waiting for an event in Step S11.

If it is judged that the key item of the slip forwarded in Step S14 has not yet been registered in the key item table, a new process identifier is issued, and a new key item i.e. a new entry is registered in the key item table using the new process identifier in Step S17. Then, after information about that process is written in the process table in Step S18, the processing of Step S16 is executed, and then, the process goes back to the processing of waiting for an event in Step S11.

If the event that occurred in Step S11 is judged to be receiving interprocess associating information sent from another corporation, the key item table is retrieved in a combination of item code and item value, the process of A corporation in which the same key item as the one used in the process of another corporation is used is checked in Step S19. The process checked is written in the interprocess associating table as the process associated with a process of another corporation in Step S20, and then the process goes back to the processing of waiting for an event in Step S11 again.

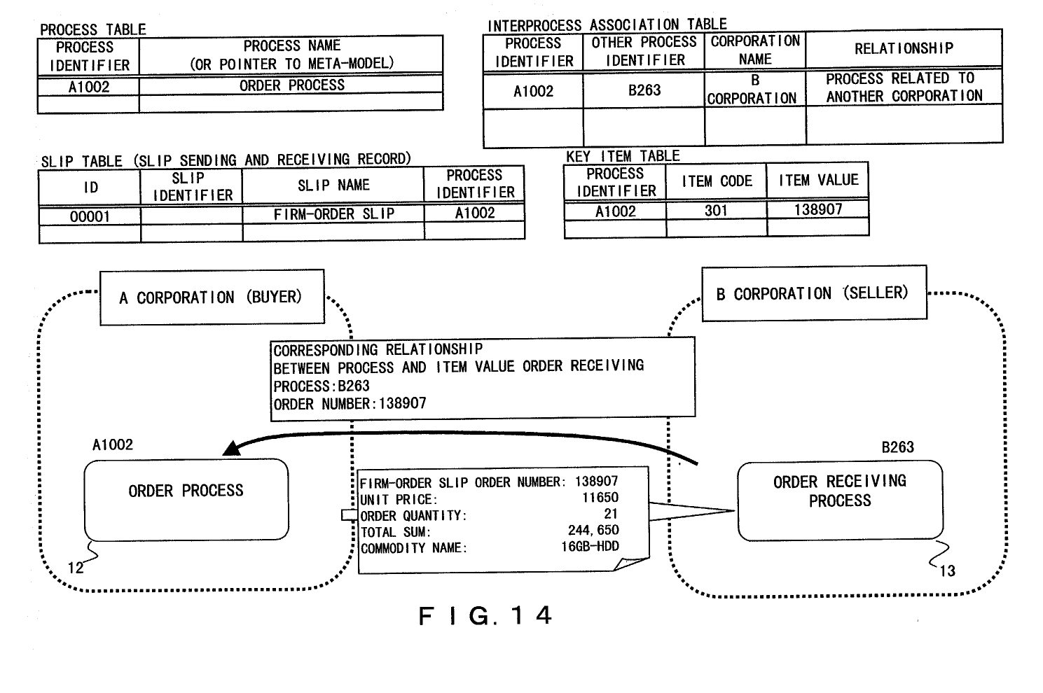

FIG. 14 is a diagram showing examples of the contents of the association index 42 made by the processing shown in FIG. 13. FIG. 14 shows the process table, interprocess association table, slip table and key item table corresponding to the order process on the side of A corporation with identifier A1002 as the contents of the association index 42 made in FIG. 6 on the side of A corporation. That is, FIG. 14 shows examples of data that are stored when A corporation sends a firm-order slip to B corporation, and B corporation sends A corporation association information that shows that 138907 is the order number corresponding to identifier B263 in the order receiving process as information about the corresponding relationship between a process and an item value.

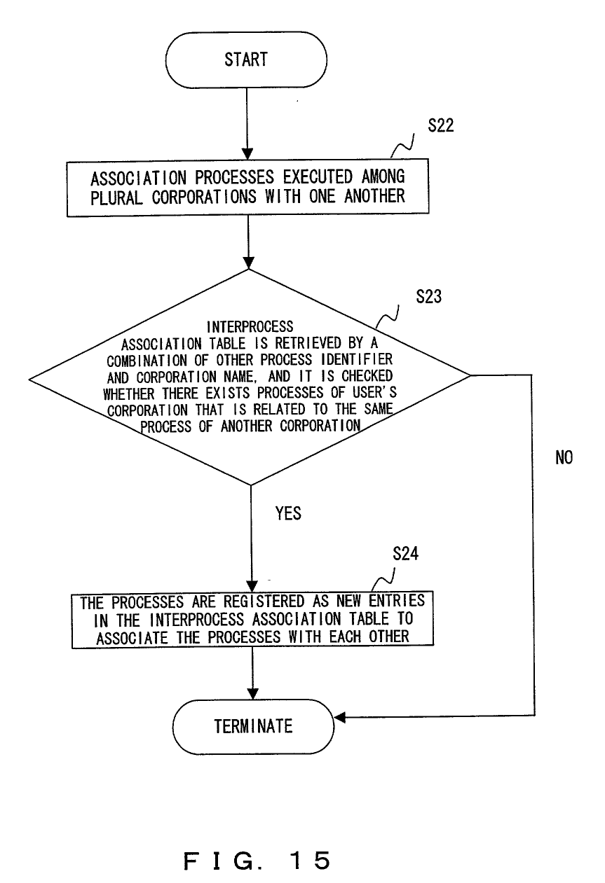

FIG. 15 is a flowchart showing the process of association processes with each other in one corporation using interprocess association information received from another corporation. When the processing is started in FIG. 15, first, association processes with each other among a plurality of corporations is performed in Step S22, the interprocess association table is retrieved by a combination of the other process identifier and the corporation name in Step S23, whether there exist a plurality of processes of one corporation that are associated with the same processes of other corporations is checked, the processing is terminated if there are no such processes, associating data are stored in a new entry of the interprocess association table in Step S24 to associate these processes if there exist such processes, and the processing is terminated.

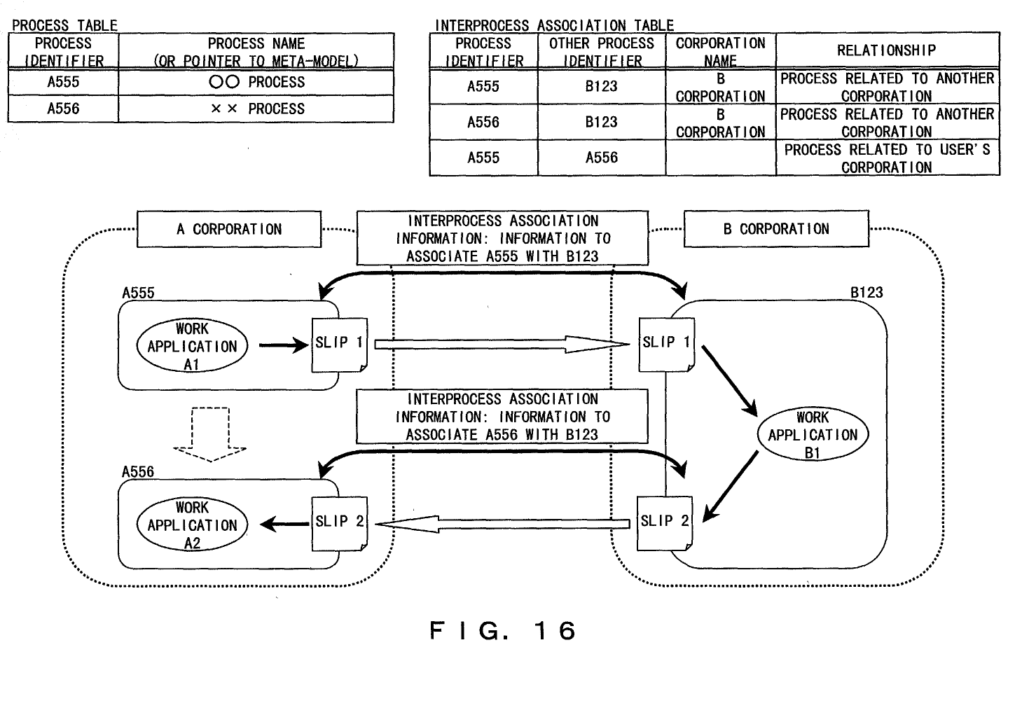

FIG. 16 is a diagram showing examples of two processes in a corporation, for instance, the processes with identifier A555 and the process with identifier A556 as associated processes stored in the association index made by the processing shown in FIG. 15. Whether the process with identifier A555 is mutually associated with the other process with identifier A556 is not clear in the process table. However, the fact that the process with identifier A555 is associated with the process with identifier A556 is stored as processes related to user's corporation (A corporation) in the interprocess association table of A corporation, by interchanging interprocess association information to associate the process with identifier A555 with the process with identifier B123, with interprocess association information to associate the process with identifier A556 with the process with identifier B123, between A corporation and B corporation.

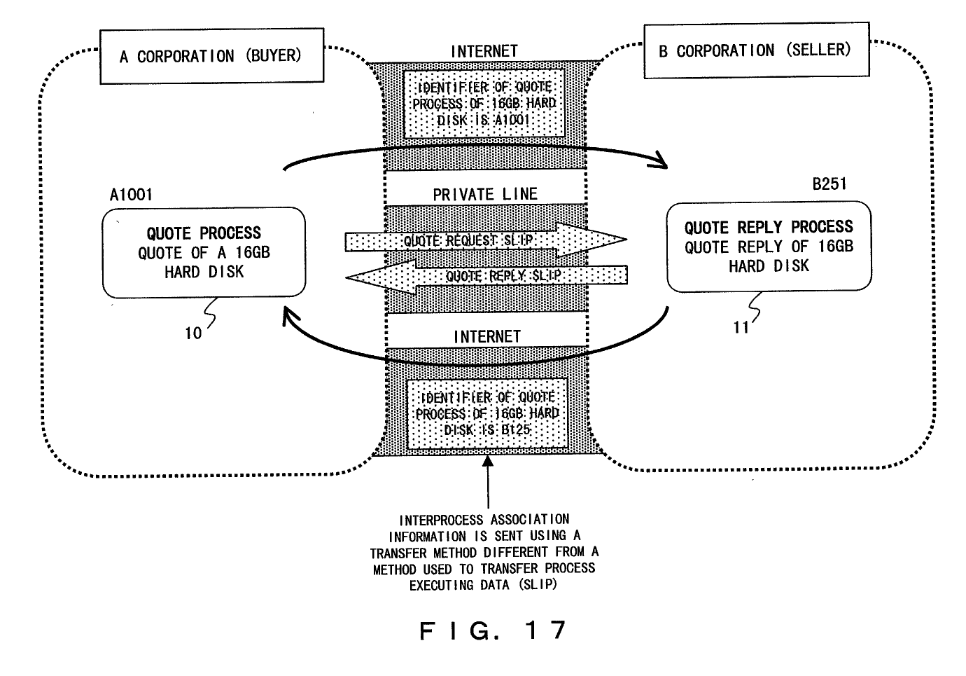

A basic mode for realizing this invention has been described. Various modes are further described hereinafter. FIG. 17 is a diagram showing an embodiment that transmits and receives interprocess association information via the Internet. The EDI system of this invention can transmit and receive process executing data, for instance, a slip and interprocess association information together. In addition, to enable this invention to be applied to even a conventional EDI system, for example, that is not designed to transmit and receive interprocess association information, the EDI system of this invention makes it a basic requirement to transfer process executing data and interprocess association information by way of a different transfer method or at a different timing. It is thereby not necessary to make a large modification to an existing EDI system.

In FIG. 17, a quote request slip and a quote reply slip are transmitted between the quote process 10 with identifier A1001 of A corporation and the quote reply process 11 with identifier B251 of B corporation, via a private line between both corporations, but interprocess association information is transmitted and received by a transfer method other than a private line via the Internet between A corporation and B corporation.

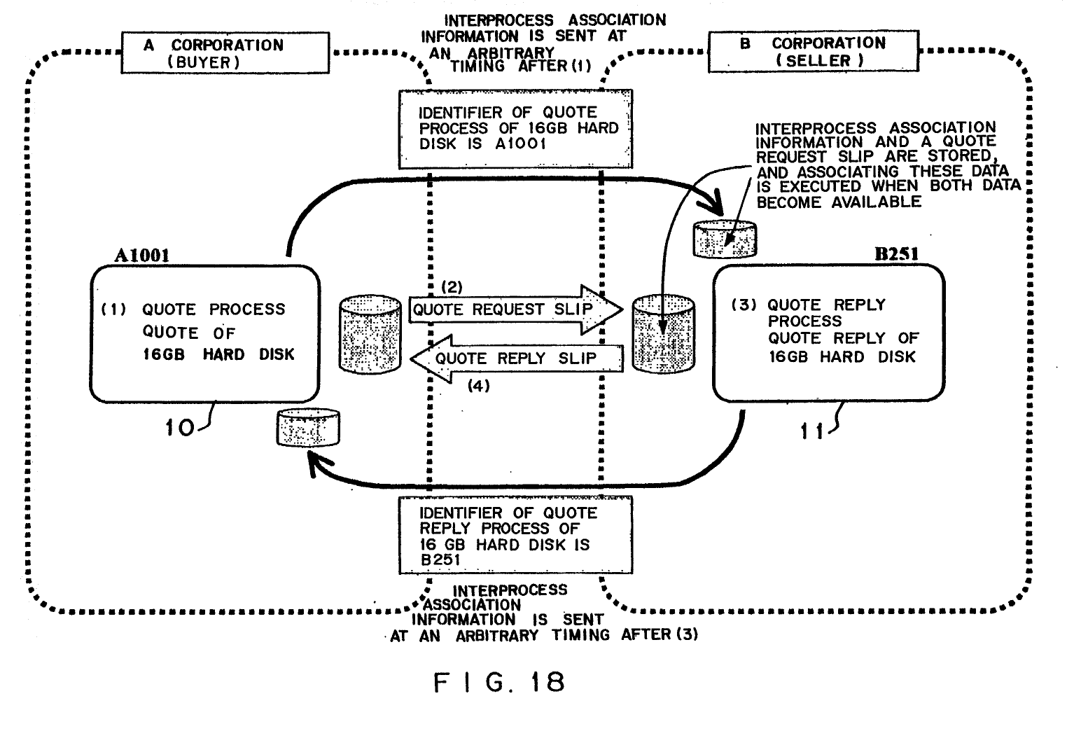

FIG. 18 is a diagram showing the timing of transmitting interprocess association information. In this embodiment, to apply this invention to a conventional EDI system that is not designed to transmit and receive interprocess association information other than process executing data, interprocess association information can be transmitted at an arbitrary different timing that is not synchronized with the timing of transmitting process executing data, for instance, a slip.

Also, in association processes with one another among a plurality of systems, if the processing of association processes with one another is executed at the timing synchronized with that of transferring process executing data, the efficiency for executing the process is likely to decrease. Therefore, process executing data and interprocess association information are transferred at a different timing, and association processes with one another is executed when both the process executing data and interprocess association information become available on the side of the receiver to prevent the efficiency for executing the process from decreasing due to the processing of association processes with one another.

When process executing data and interprocess association information are transferred at a different timing, such a situation can occur that association processes with one another is not executed though the process has been taken over. This situation is not serious depending upon the purpose of using the association of processes. For instance, tracking the result of executing the process later, that is, in the case where the cause of an error is investigated by tracing the history of executing the process, is true of such a situation. It is possible to adjust the discrepancy between the timing of taking over a process and the timing of association processes with each other according to the purpose of using the association of processes.

In FIG. 18, when the quote process 10 with identifier A1001 is started by A corporation, A corporation can send interprocess association information showing that the identifier for the quote process is A1001 at any arbitrary timing before sending a quote request to B corporation or after sending it. B corporation stores this interprocess association information and the quote request slip, and can associate the interprocess association information with the quote request slip when both data become available.

Likewise, when the quote reply process 11 with identifier B251 is started by B corporation, B corporation can send A corporation interprocess association information showing that the identifier for the quote reply process is B251 at any arbitrary timing before sending a quote reply to A corporation or after sending it.

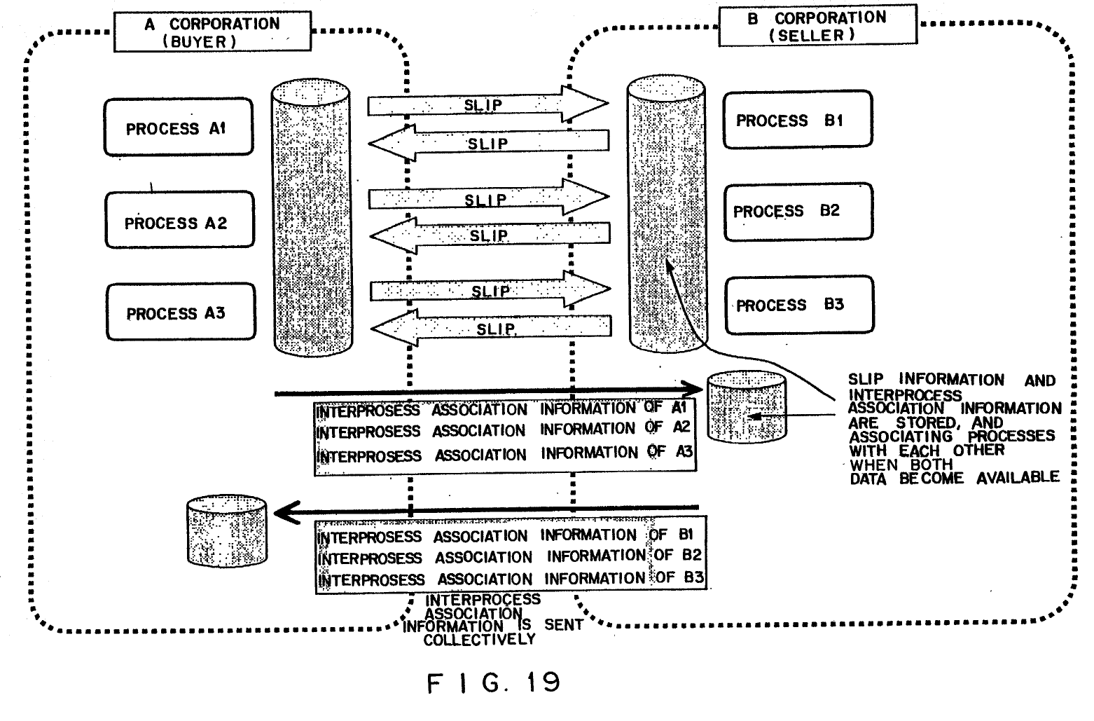

FIG. 19 is a diagram showing an embodiment of transmitting and receiving interprocess association information at a different timing from that of FIG. 18. The timing of interchanging interprocess association information that is different from the timing of sending and receiving a slip is determined in advance between A corporation and B corporation, and interprocess association information is collectively sent at the determined timing. A corporation and B corporation retain the slip information and the interprocess association information, and when both data for one process become available, both corporations can associate both data when both data for a process are obtained. Both the party sending data and the party receiving data can reduce the burden in sending and receiving data, compared with the case where interprocess association information is sent independently of process executing data.

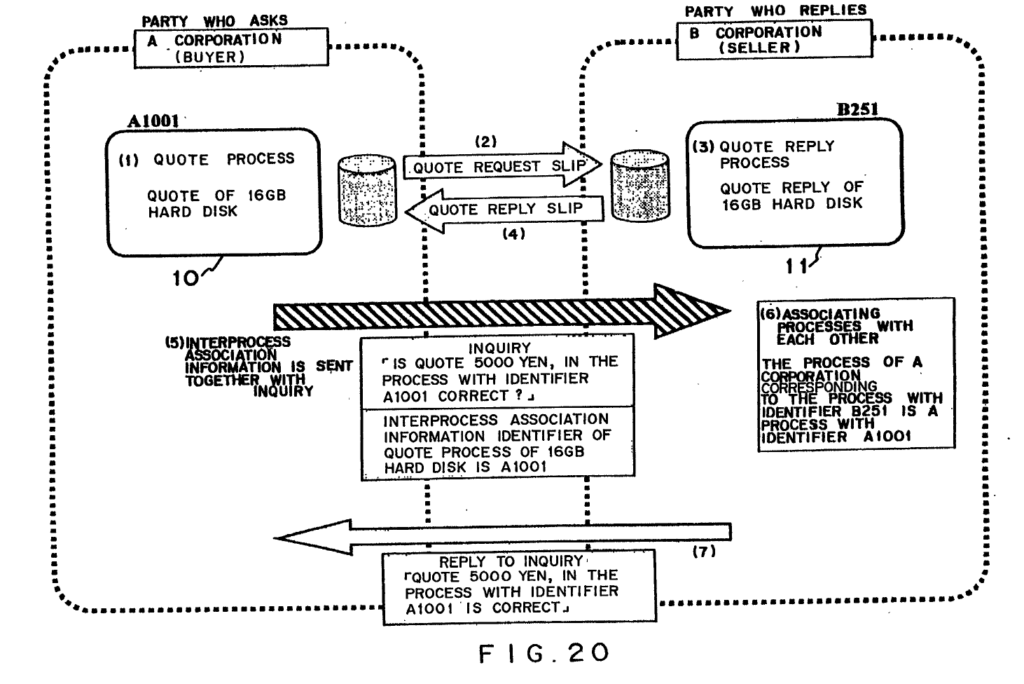

Described above is the case where interprocess association information corresponding to process executing data is interchanged in an EDI system. However, such an embodiment that interchanges interprocess association information only when it is required can also be considered. FIG. 20 shows an example of such an embodiment. In this embodiment, interprocess association information is interchanged only when A corporation asks B corporation about the process related to the process of A corporation, and A corporation, the party that asks, sends interprocess association information to B corporation, the party that replies, and then, B corporation associates the processes with each other.

In FIG. 20, the quote process 10 with identifier A1001 of A corporation, the party that asks, is started in (1), and a quote request slip is sent to B corporation, the party that replies, in (2). Then, B corporation starts the quote reply process 11 with identifier B251 in (3), and sends a quote reply slip to A corporation in (4).

After that, in order for A corporation to ask B corporation whether the estimated price, 5,000 yen, in the process with identifier A1001 is correct, A corporation sends interprocess association information together with said question to B corporation in (5). B corporation associates the quote reply process with identifier B251 with the process with identifier A1001 of A corporation using the received interprocess association information in (6), and sends A corporation a reply stating that the price, 5,000 yen, estimated in the process with identifier A1001 is correct, in (7).

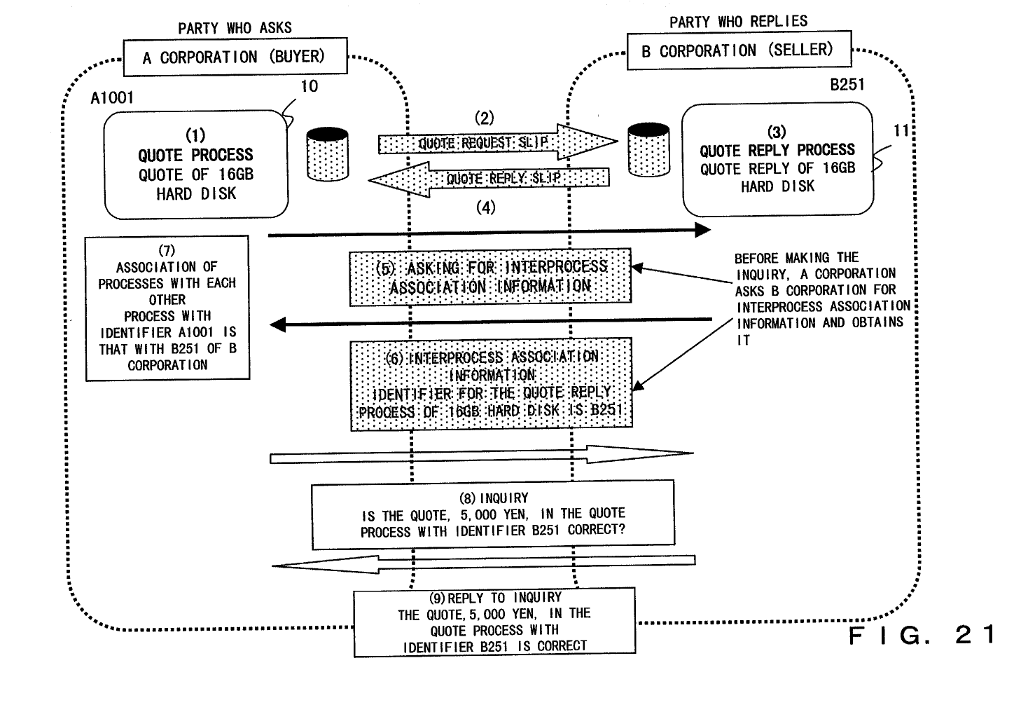

FIG. 21 is a diagram showing another example of interchanging interprocess association information when one corporation inquires about a process of the other. In FIG. 21, A corporation, a party who asks, asks B corporation, a party who replies, for interprocess association information, and A corporation, the party who asks, associates processes with each other using the interprocess association information sent from B corporation, the party who replies, and then A corporation inquires about the process of B corporation.

In FIG. 21, the order of the processes from (1) to (4) are the same as that in FIG. 20. Before A corporation asks for a quote reply, A corporation asks B corporation for interprocess association information in (5), the interprocess association information is sent by B corporation in (6), A corporation associates the processes with each other in (7), and after that, A corporation asks B corporation about the estimated price in the process with identifier B251 in (8), and B corporation replies to it in (9).

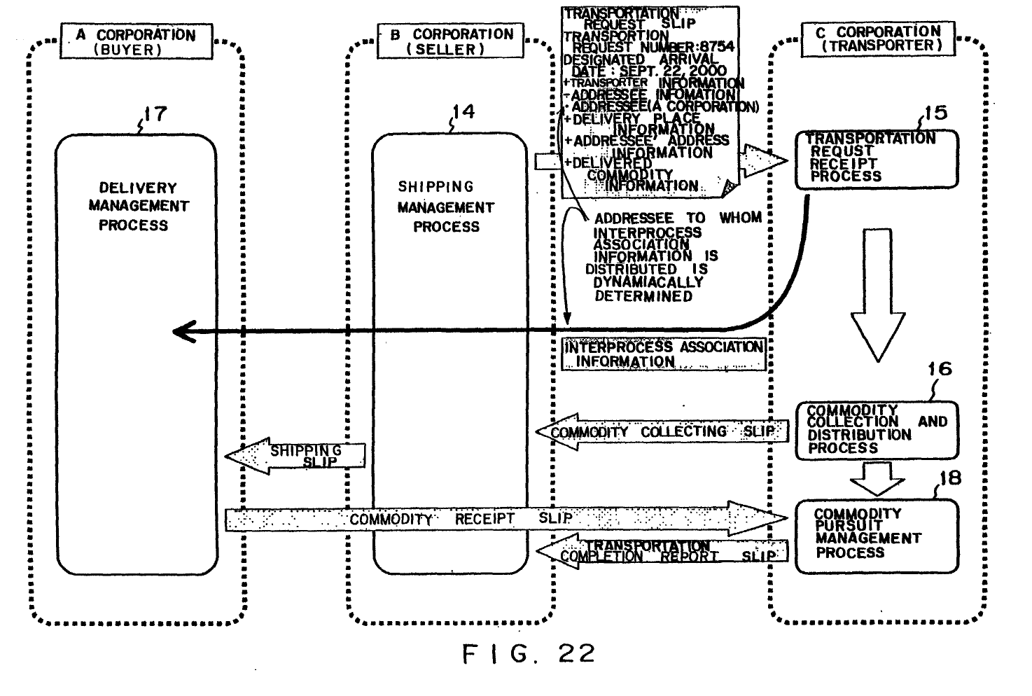

FIG. 22 is a diagram showing an embodiment of dynamically determining an addressee of interprocess association information. When one wants to send interprocess association information to another system related to the process, one sometimes cannot judge to which system one should send the information. This is such a case that until the process is actually executed, one does not know which system is involved in the process. To solve this problem, in sending interprocess association information, the addressee of the interprocess association information is dynamically determined in accordance with the item value in the process executing data in this embodiment.

In FIG. 22, B corporation (seller) sends a transportation request slip to C corporation (transporter). Since in the transpotation request receipt process 15 of C corporation, the item of the addressee in the transportation request slip is A corporation, C corporation dynamically determines that interprocess association information for the transportation request receipt process 15 should be sent to A corporation. C corporation send the information A corporation, A corporation receives the information, for example, in the delivery management process 17.

In general, the method for association processes with one another varies according to a change of the system linkage mode. A change of the system linkage mode is often provoked due to a change of works (jobs), and can frequently take place at the age of weeding out of enterprises. Therefore, if the method for associating processes with one another is determined when the system is assembled, the system must be re-assembled each time the system linkage mode is changed, causing the cost involved therein to be greatly increased. In this embodiment, on the other hand, the method for association processes with one another is stored as an association definition in the system in advance. Therefore, it is possible to change the method for association processes with one another by performing the association based upon the definition.

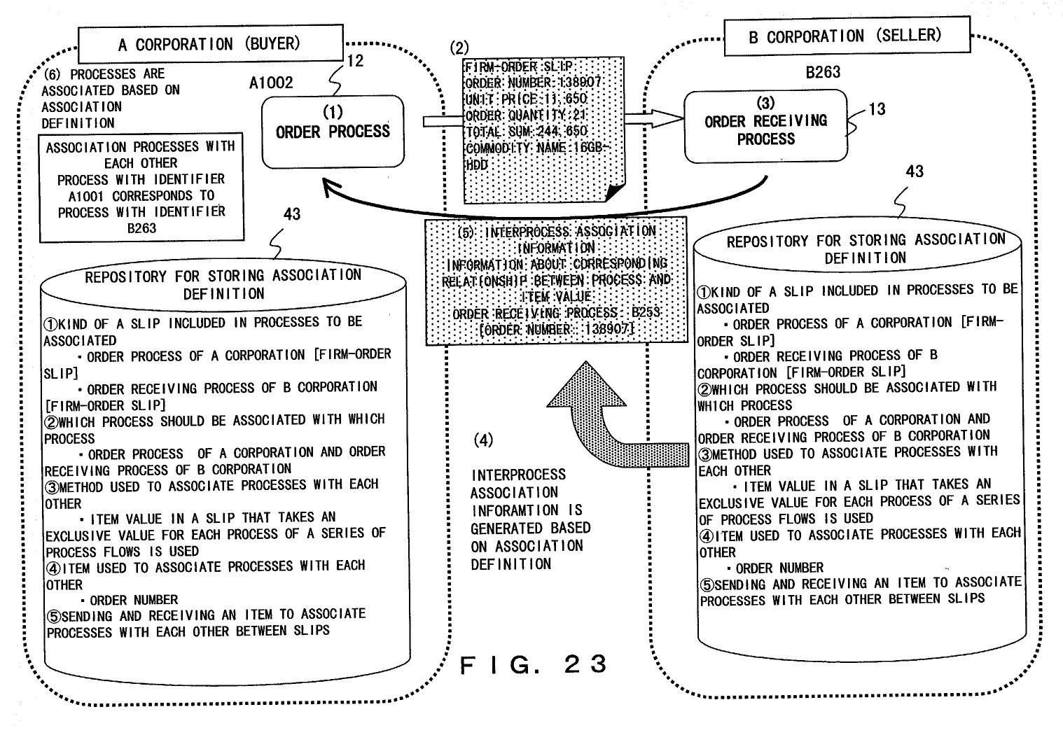

FIG. 23 is a diagram showing such an embodiment. In FIG. 23, A corporation starts the order process 12 in (1), and sends a firm-order slip to B corporation in (2), B corporation starts the order receiving process 13 in (3), makes interprocess association information based upon an association definition in (4), and sends the association information to A corporation in (5). A corporation associates the processes with each other based upon the association definition in (6), and associates the process with identifier A1002 with the process with identifier B263 of B corporation.

Stored in the association definition storing repository are association definitions such as: \mathring{1} kind of a slip included in the processes to be associated, \mathring{2} processes, in general, two processes, to be associated, \mathring{3} method for associating processes, for example, method of using a slip value in a slip that takes an exclusive value for each process of a series of process flows, \mathring{4} item used to associate processes with each other, for example, order number, \mathring{5} sending and receiving an item to be associated between slips, for example, sending and receiving an order number between a firm-order slip and a shipping slip, as described in FIG. 5 and FIG. 6.

Interchanging of interprocess association information for the case where the number of corporations that belong to an intersystem linkage work-flow system is comparatively small and that has been explained. If the number of corporations that belong to an intersystem linkage work-flow system is large, the amount of interprocess association information to be sent and received becomes very large, and the cost for distributing the interprocess association information greatly increases as a whole. In this embodiment, therefore, to solve these problems, an interprocess association information distributing server is used for receiving interprocess association information from an in-house EDI system of each corporation, concentratedly managing the information, and carrying put distribution of the information to many corporations concerned.

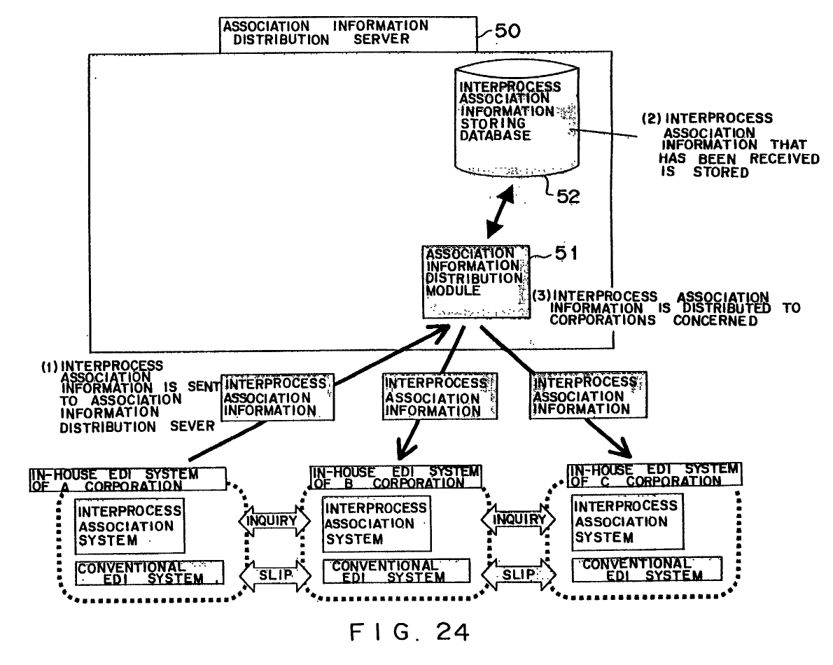

FIG. 24 is a diagram showing an association information distributing server provided in an intersystem linkage work-flow system. An association information distributing server 50 is basically composed of an association information distribution module 51 and an interprocess association information storing database 52. Each in-house EDI system sends interprocess association information to the association information distributing server 50 in (1), the server 50 stores the received interprocess association information in the interprocess association information storing database 52 in (2), and the server 50 distributes the association information to each in-house EDI system of the corporations concerned via the association information distribution module 51 in (3).

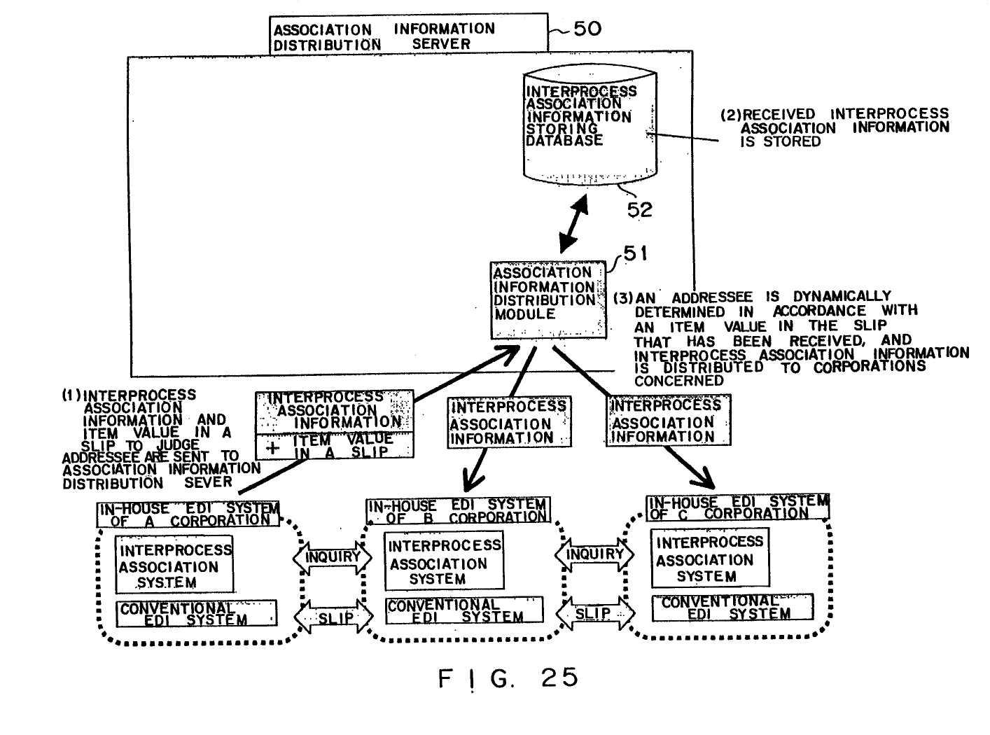

FIG. 25 is a diagram showing an embodiment for an association information distributing server to dynamically determine an addressee of the association information in accordance with the item value in a slip in distributing association information. This is the embodiment that is used in the case where the system that becomes related to the process is unknown until the process is executed.

In FIG. 25, the EDI system of each corporation sends, for instance, the in-house EDI system of A corporation sends interprocess association information and the item value in a slip that is used to judge the addressee to whom the association information is distributed to the association information distributing server 50 in (1), the association information is stored in the interprocess association information storing database 52 in (2), the association information distribution module 51 dynamically determines the addressee of the association information in accordance with the item value in the received slip, and the module 51 distributes the information to the corporations concerned in (3).

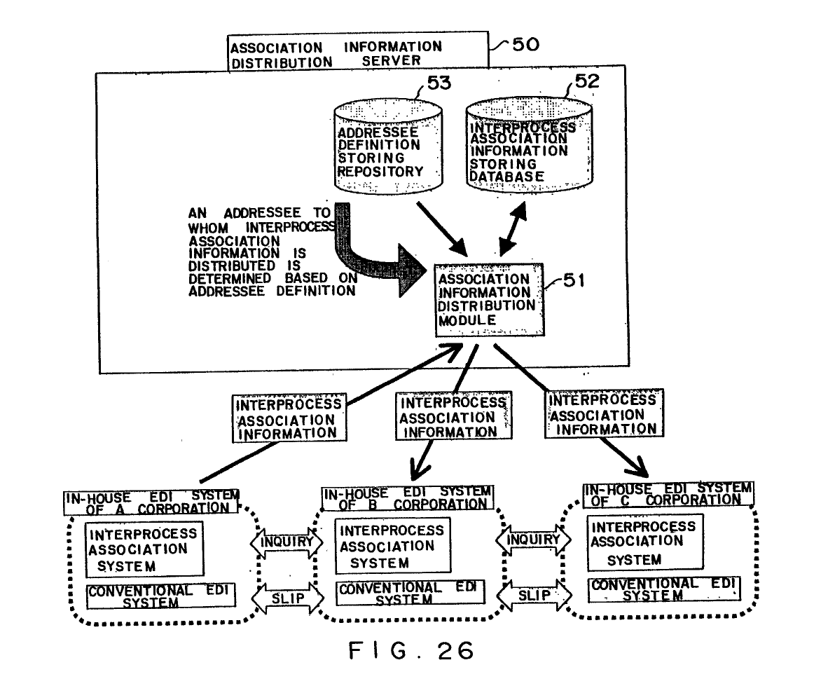

As an embodiment of this invention, it is possible to consider such a method that the association information distributing server retains the definition about an addressee of the association information, and the server distributes association information based upon the definition. FIG. 26 shows an embodiment of such an association information distributing server. The association information distributing server 50 explained in FIG. 24 and FIG. 25 is provided with an addressee definition storing repository 53.

In FIG. 26, four kinds of information are stored in the addressee definition storing repository 53. The first is information about each corporation, such as an addressee, namely the distribution address of an addressee and the distribution method for distributing association information. The second is information about processes that are executed by each corporation. The third is information about which processes should be associated among corporations concerned. The fourth is information about the method for associating processes with one another.

In FIG. 26, the association information distributing server 50 determines the addressee of interprocess association information, which is the information stored in the interprocess association information storing database 52, based upon the contents of the addressee definition storing repository 53, and distributes the association information to the determined addressee via the association information distribution module 51.

In general, the process of interprocess association information that should be sent to a corporation varies according to each process. If all the distributing methods are built into the association information distributing server, the cost for it becomes enormously large. So, in this embodiment, an addressee of interprocess association information and the method for distributing the information are stored as an addressee distributing definition, and the interprocess association information is distributed based upon said definition, thus making it possible to reduce the cost.

In the association information distributing server 50 shown in FIG. 26, as in FIG. 25, it is also possible to dynamically determine an addressee in accordance with the item value by receiving the item value in a slip in addition to the interprocess association information from the EDI system of each corporation.

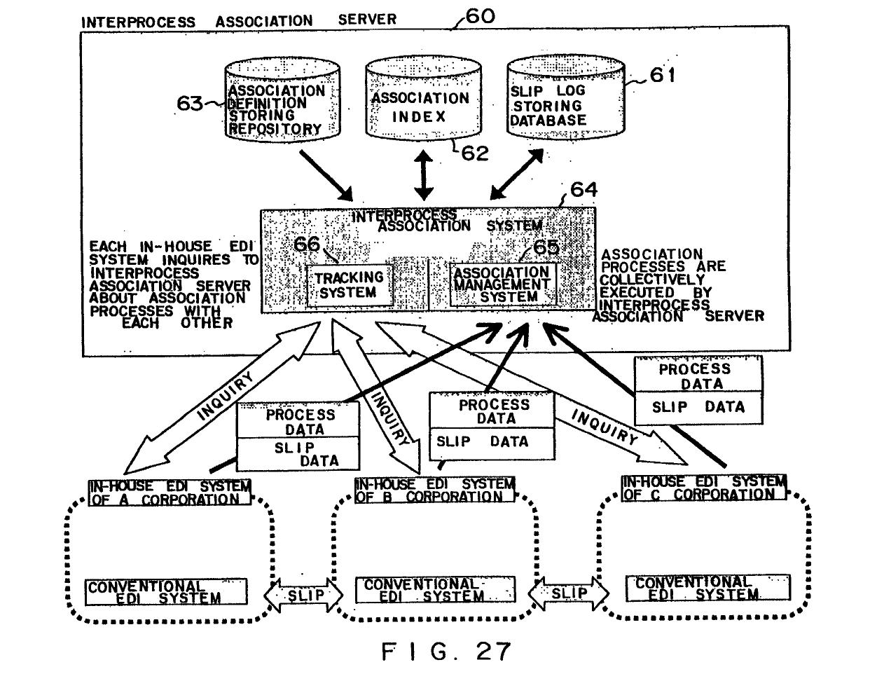

An embodiment of the invention has been described on the premise that association processes with one another is basically performed by the EDI system of each corporation. However, it is also possible to make the function for associating processes with one another independent of the EDI system of each corporation. FIG. 27 is an embodiment of such an invention.

In FIG. 27, an interprocess association server 60 that concentratedly executes the function for association processes with one another is provided in an intercorporation EDI system as an intersystem linkage work-flow system, and each in-house EDI system can leave the work of associating processes with one another and leave the work for distributing association information entirely to the interprocess association server 60. Also, when the in-house EDI system of each corporation inquires about association information, it can ask only said server. Therefore, the cost for distributing interprocess association information can be reduced, and the efficiency of work by an intercorporation EDI system can be enhanced.

The interprocess association server 60 shown in FIG. 27 is such a system that a plurality of the interprocess association systems 40 provided in the in-house EDI system explained in FIG. 8 to cope with all the corporations concerned are integrated into one system. The server 60, as is the case with the interprocess association system 40 shown in FIG. 8, is provided with a slip log storing database 61, an association index 62, an association definition repository 63, and an interprocess association system 64. The interprocess association system 64 is provided with an association management system 65 and a tracking system 66.

Assume that the in-house EDI system of each corporation is not provided with an interprocess association system in it, contrary to the one shown in FIG. 26, but is provided with only a conventional EDI system. Therefore, the in-house EDI system, as in FIG. 8, sends process data and slip data to an interprocess association system 64 of an interprocess association server 60. The interprocess association server 60 collectively associates processes with each other using these data, and manages the associated information. When, for instance, the in-house EDI system needs to inquire about interprocess association information, it asks the interprocess association server 60 about the information.

Finally, described hereinafter is the loading of a program in an embodiment of this invention into a computer. The in-house EDI system of each corporation that composes an intercorporation EDI system as an intersystem linkage work-flow system of this invention is a data interchange device for interchanging data with other in-house EDI systems, and executing the process based upon the interchanged data. Naturally, this system can be realized by a general computer.

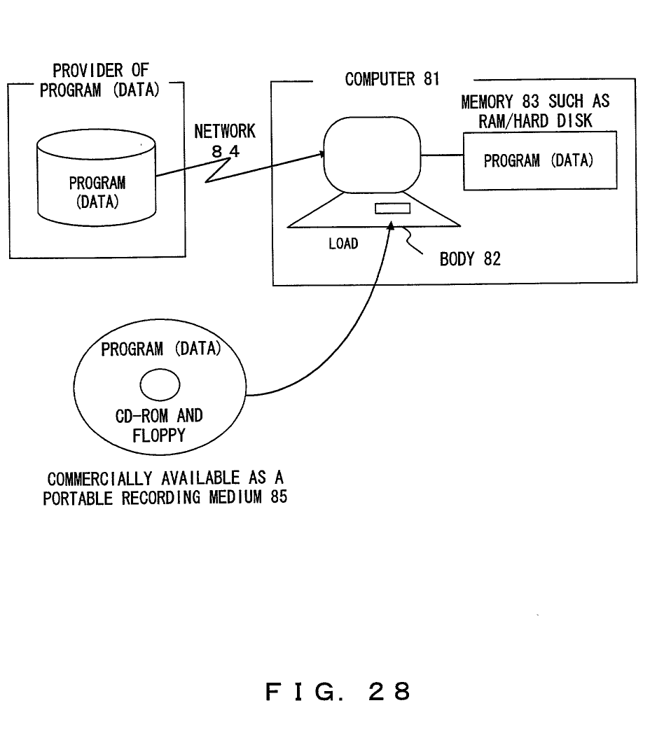

FIG. 28 is a diagram showing the configuration of such a computer system. A computer 81 is composed of a machine 82 and a memory 83. The operation of an intersystem linkage work-flow system of this invention is realized by executing a program stored in the memory 83 by the body 82.

Various kinds of storages such as a random access memory (RAM), a hard disk and a magnetic disk can be used as the memory 83. Included in this memory 83 are a program described in FIGS. 11, 13 and 15. Such programs are executed by the body 82, and then the in-house EDI system sends and receives interprocess association information with the in-house EDI systems of other corporations, and executes a series of processes in cooperation with processes executed by other corporations. That is, a series of work flows can be executed.

A program provider sends a program to the computer 81 via a network 84, and the program is loaded into the computer 81. Also, such a program is stored in a portable storage medium 85 that is commercially available, and the program stored in the storage medium is loaded into the computer 81. Then, an intersystem work-flow system of this invention can also be realized. Various types of storage mediums such as a CD-ROM, a floppy disk and an optical disk can be used as the portable storage medium 85.

If this invention is used, even a work-flow system that does not have a mechanism for sending and receiving a process identifier can associate processes with one another among a plurality of systems only by sending and receiving data for executing a process. In addition, since a common process identifier is not used among a plurality of systems, it is possible to associate processes with one another even when the top of a process is not determined.

Also, a process that cannot be associated with other processes in one corporation can be associated by using association information that associates the process executed by a system of another corporation.

Furthermore, the cost for distributing interprocess association information by a work-flow system composed of many systems can be reduced by providing a server that distributes interprocess association information in the work-flow system, and an addressee of the information can be easily managed. Association processes with one another can also effectively be performed by providing a server that concentratedly executes association processes with one another, and any in-house EDI system can ask only the server about the process, thus greatly contributing to enhancing the efficiency for executing a series of process flows in an interprocess linkage work-flow system.

While the invention has been described with reference to the preferred embodiments thereof, various modifications and changes may be made by those skilled in the art without departing from the true spirit and scope of the invention as defined by the claims thereof.

What is claimed is:

1. A data interchange system for executing a series of process flows among a plurality of process executing devices, the process executing device comprising:
a process executing data interchanging unit interchanging process executing data for executing a process with other process executing device, and
an interprocess association information interchanging unit interchanging with the other process executing device of interprocess association information that associates the process executed by the process executing device with the process executed by the other executing device.

2. The data interchange system according to claim 1, wherein,
said interprocess association information is information that associates the processes with one another using a part of the process executing data.

3. The data interchange system according to claim 1, wherein,
said interprocess association information is part of the process executing data, and is the information for associating processes with each other using data that takes an exclusive value for each process of the series of process flows.

4. The data interchange system according to claim 1, wherein,
said interprocess association information interchanging unit interchanges the interprocess association information with the other process executing device using a transfer method different from the method used by said process executing data interchanging unit.

5. The data interchange system according to claim 1, wherein,
said interprocess association information interchanging unit interchanges the interprocess association information at a timing that is not synchronized with the timing for interchanging the process executing data by said process executing data interchanging unit.

6. The data interchange system according to claim 5, wherein,
said interprocess association information interchanging unit periodically and collectively interchanges the interprocess association information.

7. The data interchange system according to claim 5, wherein,
said interprocess association information interchanging unit transmits to the other process executing device inquiry information for inquiring about the process which is executed by the other process executing device and is related with the process executed by the process executing device in addition to the process association information, and wherein
the other process executing device further comprising:
an inquiry response unit associating the processes executed by both process executing devices and responding to the inquiry information from the process executing device.

8. The data interchange system according to claim 5, wherein,
the process executing device further comprising:
a process association information request unit requesting said interprocess association information interchanging unit in the other process executing device to transmit the interprocess association information necessary for an inquiry about the process which is executed by the other process executing device and is which related to the process executed by the process executing device in addition to the process association information before the inquiry; and
an inquiry unit for associating the processes executed by both process executing devices using the transmitted process association information and performing the inquiry based on the association result.

9. The data interchange system according to claim 1, wherein,
said interprocess association information interchanging unit dynamically determines the other process executing device to which the interprocess association information is transmitted using a part of the process executing data.

10. The data interchange system according to claim 1, wherein,
said process executing device further comprising:
an association definition storing unit storing a method to define the interprocess association as an association definition; and
an association unit associating the process executed by the process executing device with the process executed by the other process executing device.

11. The data interchange system according to claim 1, wherein,
said process executing device further comprising:
a device interprocess association unit associating the processes executed by the process executing device that are identical to the process executed by the other process executing device using the interprocess association information transmitted from the other process executing device.

12. A data interchange system for executing a series of process flows among a plurality of process executing devices, comprising:
an interprocess association information storing unit storing an interprocess association information that associates a process executed by each of said plurality of process executing devices with the process executed by the other executing device, which is transmitted by the plurality of process executing devices; and
an interprocess association information distribution unit distributing the interprocess association information stored in said interprocess association information storing unit to the process executing device which is related to the interprocess association information.

13. The data interchange system according to claim 12, further comprising:
an addressee definition storing unit storing a method for determining an addressee of the interprocess association information as an addressee definition,
and said interprocess association information distribution unit distributes interprocess association information based on the addressee definition.

14. The data interchange system according to claim 12, wherein,
said interprocess association information distribution unit dynamically determines the addressee of the process association information using a part of a process executing data transmitted from the plurality of process executing devices.

15. A data interchange system for executing a series of process flows among a plurality of process executing devices, comprising:
an interprocess association unit associating the processes executed among the plurality of process executing devices using the data transmitted from the plurality of process executing devices and generating process association information; and
an interprocess association information distribution unit distributing the process association information generated by said interprocess association unit to the process executing device which is related to the interprocess association information.

16. A data interchange device for interchanging data concerning a process included in a series of process flows with an external device, comprising:
an executing data interchanging unit interchanging a process executing data with the external device; and
an interprocess association information interchanging unit interchanging with the external device interprocess association information which associates a process executed by the process executing device with the process executed by the external device.

17. A data interchange method for interchanging data concerning a process included in a series of process flows with an external device, comprising:
interchanging process executing data with the external device; and
interchanging with the external device interprocess association information which associates the process executed by the process executing device with the process executed by the external device.

18. The data interchange method according to claim 17, wherein,
in interchanging the interprocess association information, the process executing device uses a data tranfer method different from a method for interchanging the process executing data.

19. A storage medium which stores a program to make a computer to control interchanging data concerning a process included in a series of process flows with an external device, the program to make said computer perform the step of:
interchanging process executing data with the external device; and
interchanging with the external device interprocess association information which associates the process executed by the process executing device with the process executed by the external device.

20. The storage medium according to claim 19, wherein,
in interchanging the interprocess association information, the process executing device uses a data tranfer method different from a method for interchanging the process executing data.

21. A data interchange device for interchanging data concerning a process included in a series of process flows with an external device, comprising:
executing data interchanging means for interchanging process executing data with the external device; and
interprocess association information interchanging means for interchanging with the external device interprocess association information which associates the process executed by the process executing device with the process executed by the external device.

22. A computer data signal embodied in a carrier wave and representing a program that makes a computer to control interchanging data concerning a process included in a series of process flows with an external device, and the program making the computer execute the step of:
interchanging process executing data with the external device; and
interchanging with the external device interprocess association information which associates the process executed by the process executing device with the process executed by the external device.
